(19) United States
(12) Patent Application Publication
(10) Pub. No.: US 2022/0036323 A1
(43) Pub. Date: Feb. 3, 2022

(54) ELECTRONIC WALLET ALLOWING VIRTUAL CURRENCY EXPIRATION DATE

(71) Applicant: International Business Machines Corporation, Armonk, NY (US)

(72) Inventors: Yu Sasaki, Kanagawa (JP); GOYA SAKURADA, Bunkyo-ku (JP); HIROSHIGE TAKEUCHI, Tokyo (JP); MASATO TAKAI, Chuo-ku (JP); MIKIO KURIHARA, Yamato-city (JP)

(21) Appl. No.: 16/940,444

(22) Filed: Jul. 28, 2020

(51) Int. Cl. G06Q 20/06; G06Q 20/36; G06Q 20/38; H04L 9/08

(52) U.S. Cl. CPC G06Q 20/0652; G06Q 20/3678; G06Q 20/382; H04L 2209/56; G06Q 2220/00; H04L 2209/38; H04L 9/0825

(57) ABSTRACT

A computer-implemented system and method uses a processor of a device of an expiring virtual currency (EVC) wallet user. An EVC transaction is retrieved that is associated with a blockchain and addressed to an address associated with the EVC wallet. The EVC transaction comprises an expiration date for the EVCs, as part of virtual currency user rules (VCURs). If the expiration date of the EVCs has passed, the method automatically, and without user intervention, transfers the EVCs to a transferee designated in the VCURs.

### BACKGROUND

Disclosed herein is a system and related method for utilizing an electronic wallet that allows a virtual currency to have an expiration date. Virtual currencies (crypto assets) using blockchain technology have acquired a well-recognized usage as an exchange medium in industry and the world economy. A Bitcoin is one such virtual currency that has been very reliably operating for over a decade. Its reliability is such that some companies have even adopted a system for paying part of salaries in virtual currency, due to its high recognition rate and excellent convenience. A virtual currency user using a wallet application may carry out transactions including payment, money transfer, money reception, balance management and the like, using the virtual currency.

However, there are no mechanisms at present to regulate or control virtual currency usage. Once a virtual currency transaction has taken place, the receiver of the virtual currency may use it in any manner that they choose. Although this may be advantageous in some situations, it is disadvantageous in others, such as when a currency is intended to be used in a particular manner—which may be akin to a gift card whose intended use is with a particular merchant. By not allowing a control over the usage of a virtual currency, its functional value may be diminished over real currencies.

### SUMMARY

It may be desirable to have a specialized virtual currency that has an expiration date in order to encourage usage within a particular period of time. Furthermore, it may be desirable to have a predefined set of recipients having specialized virtual currency wallets to hold the specialized virtual currency and to whom transfers/transactions, prior to expiration, may be made. Upon expiration, it may a transfer may be made to a transferee in an automatic manner and without the restrictions it had prior to expiration.

According to one aspect disclosed herein, a computer-implemented method is provided comprising, using a processor of a device of an expiring virtual currency (EVC) wallet user, retrieving an EVC transaction associated with a blockchain and addressed to an address associated with the EVC wallet. The EVC transaction comprises an expiration date for the EVCs, the EVCs being subject to virtual currency user rules (VCURs) of which the expiration date is a part of. The method further determines whether the expiration date of the EVCs in the EVC transaction has passed, based on a first condition that the expiration date has passed. Once the expiration date has passed, the method automatically, and without user intervention, transfers the EVCs to a transferee designated in the VCURs. Providing a method of using an EVC subject to VCURs is advantageous in that it enhances the flexibility in using a virtual currency and can encourage EVCs to be used in a manner intended by an EVC issuer.

According to another aspect disclosed herein, an expiring virtual currency (EVC) apparatus comprises a memory and a processor. The processor is configured to retrieve an EVC transaction associated with a blockchain and addressed to an address associated with the EVC wallet. The EVC transaction comprises an expiration date for the EVCs, the EVCs being subject to virtual currency user rules (VCURs) of which the expiration date is a part of. The processor is further configured to determine whether the expiration date of the EVCs in the EVC transaction has passed, based on a first condition that the expiration date has passed, automatically, and without user intervention, transfers the EVCs to a transferee designated in the VCURs. Providing an apparatus for using an EVC subject to VCURs is advantageous in that it provides a platform for utilizing EVCs that is separate from those that use regular virtual currencies, yet at the same time allows the EVCs to be converted to regular virtual currencies under the predesignated conditions.

According to another aspect disclosed herein, a computer-implemented method for issuing expiring virtual currencies (EVCs) by an issuer comprises using a processor for creating an account list comprising a plurality of account records, each comprising an indicator as to whether an EVC recipient associated with the EVC recipient identifier is inside or outside of a predefined set of EVC recipients. The account records correspond to a plurality of EVC recipients. The method further comprises creating an EVC recipient destination list comprising a plurality of destination records, each comprising the EVC recipient identifier, the public key, the virtual currency address, and the indicator as to whether the EVC recipient is inside or outside of a predefined set of EVC recipients. The method further comprises setting an EVC recipient address and security keys for each of a plurality of EVC wallets used to hold EVCs for the EVC recipients, and distributing said each of the EVC wallets to respective said EVC recipients. Providing a method of issuing an EVC subject to VCURs is advantageous in that it permits an EVC issuer to encourage use of the EVC in a manner that the EVC issuer desires.

According to another aspect, an expiring virtual currency (EVC) system comprises an EVC issuer device as described herein. A computer program product for an expiring virtual currency apparatus comprises one or more computer readable storage media, and program instructions collectively stored on the one or more computer readable storage media, the program instructions comprising program instructions to implement the above-described methods.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1A is a block diagram of a data processing system (DPS) according to one or more embodiments disclosed herein.

FIG. 1B is a pictorial diagram that depicts a cloud computing environment according to an embodiment disclosed herein.

FIG. 1C is a pictorial diagram that depicts abstraction model layers according to an embodiment disclosed herein.

FIG. 1D is a block diagram that illustrates a network diagram of a system including a database, according to an example embodiment.

FIG. 2A is a block diagram that illustrates an example blockchain architecture configuration, according to example embodiments.

FIG. 2B is a flow diagram that illustrates a blockchain transactional flow, according to example embodiments.

FIG. 3A is a block diagram that illustrates a permissioned network, according to example embodiments.

FIG. 3B is a block diagram that illustrates another permissioned network, according to example embodiments.

FIG. 3C is a block diagram that illustrates a permissionless network, according to example embodiments.

FIG. 4 is a block diagram that illustrates a basic blockchain sequence.

FIG. 5A is a block diagram that illustrates an example system configured to perform one or more operations described herein, according to example embodiments.

FIG. 5B is a block diagram that illustrates another example system configured to perform one or more operations described herein, according to example embodiments.

FIG. 5C is a block diagram that illustrates a further example system configured to utilize a smart contract, according to example embodiments.

FIG. 5D is a block diagram that illustrates yet another example system configured to utilize a blockchain, according to example embodiments.

FIG. 6A is a block diagram that illustrates a process for a new block being added to a distributed ledger, according to example embodiments.

FIG. 6B is a block diagram that illustrates contents of a new data block, according to example embodiments.

FIG. 6C is a block diagram that illustrates a blockchain for digital content, according to example embodiments.

FIG. 6D is a block diagram that illustrates a block which may represent the structure of blocks in the blockchain, according to example embodiments.

FIG. 7A is a block diagram that illustrates an example blockchain which stores machine learning (artificial intelligence) data, according to example embodiments.

FIG. 7B is a block diagram that illustrates an example quantum-secure blockchain, according to example embodiments.

FIG. 8 is a block diagram that illustrates a high-level block diagram of an example computer system that may be used in implementing one or more of the methods, tools, and modules, and any related functions, described herein, in accordance with embodiments of the present disclosure.

FIG. 9 is a block diagram that illustrates a distributed ledger (blockchain), according to some implementations.

FIG. 10 is a block diagram illustrating transfers of two transferors to a transferee, according to some implementations.

FIG. 11A is a block diagram that illustrates use of a predefined set of EVC recipients to which the EVC may be transferred, according to some implementations.

FIG. 11B is a block diagram similar to FIG. 11A, but that additionally shows the transferee to whom unused EVCs may be automatically transferred, according to some implementations.

FIG. 12 is a flowchart illustrating a process for implementing some embodiments of a system used by the management body/issuer in creating and distributing the EVCs.

FIGS. 13A & 13B contain flowcharts of processes that may be utilized by the EVC recipients via the EVC wallet application on their devices, according to some implementations.

FIG. 14 is a flowchart illustrating a process for the automatic payment to the transferee, according to some implementations.

FIGS. 15A and 15B are parts of a combination block-process diagram illustrating components and interactions of these components for operating the system, according to some implementations.

### DETAILED DESCRIPTION

### Overview of the Electronic Wallet Allowing Virtual Currency Expiration Date

This disclosure considers use of an electronic wallet that allows a virtual currency using blockchain technology, such as virtual currencies, to be subject to certain virtual currency usage rules (VCURs) associated with the virtual currency. As defined herein, the term “virtual currency” may include digital currencies as well. One such VCUR may be to have an expiration date. As such, the term “expiring virtual currency” (EVC) is used herein for the sake of convenience to describe virtual currencies subject to VCURs (which do not necessarily include expiration dates) and to distinguish the EVCs from “regular” virtual currencies. Also, as indicated below, the term “virtual currency” as used herein is a proxy for any type of blockchain-based virtual currency, unless referred to with the adjective “regular” before “virtual currency”.

Another such VCUR is a list of recipients who have EVC wallets that are capable of receiving EVCs, and to which EVC transfers may be made. When a VCUR indicates an expiration of the EVC, such as an expiration date, the VCUR may indicate an automatic transfer of the EVC to a transferee. This transfer may convert the EVCs to regular virtual currencies, i.e., virtual currencies without the VCURs and that may be held in a normal virtual currency wallet. An EVC wallet may hold different types of electronic/digital/virtual currencies.

The following acronyms may be used below:
API application program interface
ARM advanced RISC machine
CD-ROM compact disc ROM
CMS content management system
CoD capacity on demand
CPU central processing unit
CUoD capacity upgrade on demand
DPS data processing system
DVD digital versatile disk
EVC expiring virtual currency (a virtual currency having an expiration date, or subject to other virtual currency usage rules; local virtual currencies with expiration dates)
EVCU expiring virtual currency (units)
EPROM erasable programmable read-only memory
FPGA field-programmable gate arrays
HA high availability
IaaS infrastructure as a service
I/O input/output
IPL initial program load
ISP Internet service provider
ISA instruction-set-architecture
LAN local-area network
LPAR logical partition
PaaS platform as a service
PDA personal digital assistant
PLA programmable logic arrays
RAM random access memory
RISC reduced instruction set computer
ROM read-only memory
SaaS software as a service
SLA service level agreement
SRAM static random-access memory
VCUR virtual currency usage rules
WAN wide-area network

### Data Processing System in General

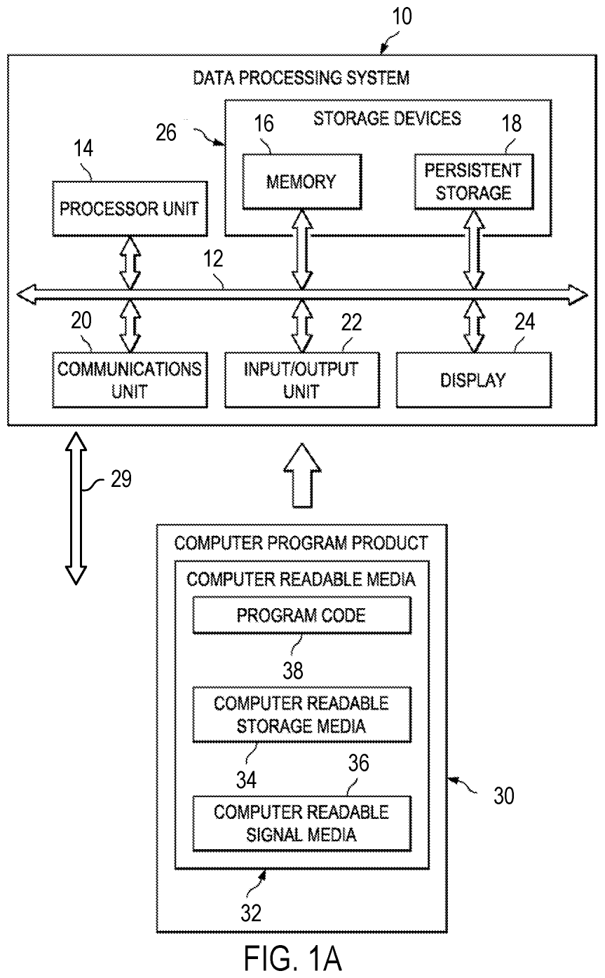

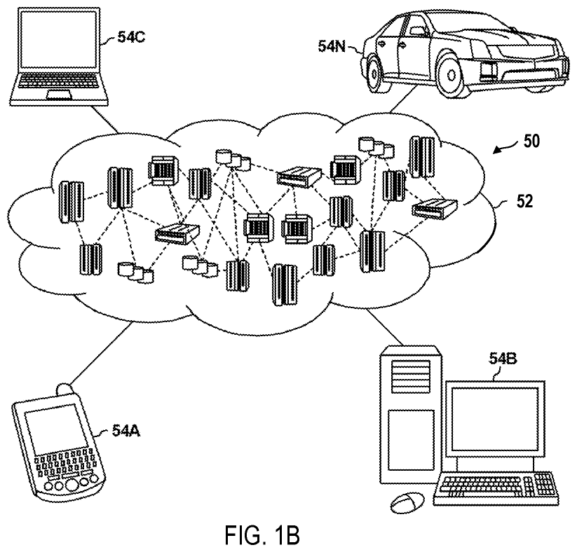

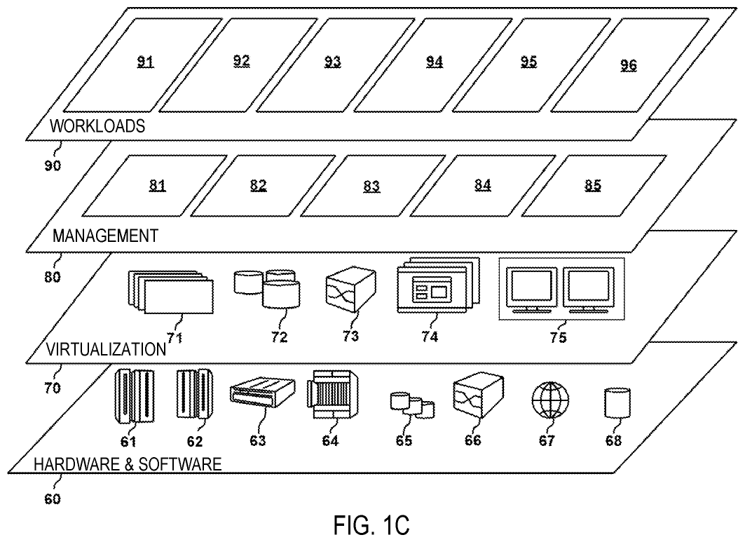

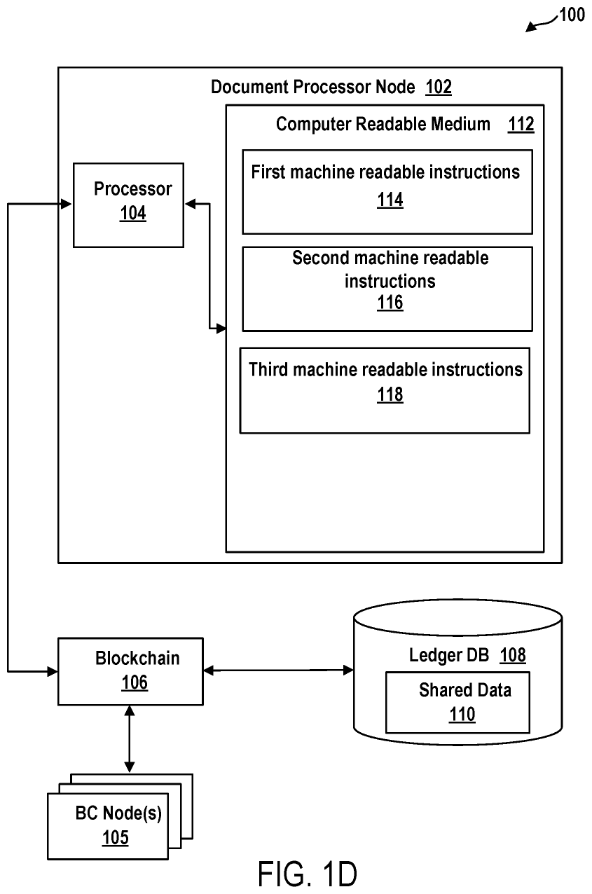

FIG. 1A is a block diagram of an example DPS according to one or more embodiments. In this illustrative example, the DPS 10 may include communications bus 12, which may provide communications between a processor unit 14, a memory 16, persistent storage 18, a communications unit 20, an I/O unit 22, and a display 24.

The processor unit 14 serves to execute instructions for software that may be loaded into the memory 16. The processor unit 14 may be a number of processors, a multi-core processor, or some other type of processor, depending on the particular implementation. A number, as used herein with reference to an item, means one or more items. Further, the processor unit 14 may be implemented using a number of heterogeneous processor systems in which a main processor is present with secondary processors on a single chip. As another illustrative example, the processor unit 14 may be a symmetric multi-processor system containing multiple processors of the same type.

The memory 16 and persistent storage 18 are examples of storage devices 26. A storage device may be any piece of hardware that is capable of storing information, such as, for example without limitation, data, program code in functional form, and/or other suitable information either on a temporary basis and/or a permanent basis. The memory 16, in these examples, may be, for example, a random access memory or any other suitable volatile or non-volatile storage device. The persistent storage 18 may take various forms depending on the particular implementation.

For example, the persistent storage 18 may contain one or more components or devices. For example, the persistent storage 18 may be a hard drive, a flash memory, a rewritable optical disk, a rewritable magnetic tape, or some combination of the above. The media used by the persistent storage 18 also may be removable. For example, a removable hard drive may be used for the persistent storage 18.

The communications unit 20 in these examples may provide for communications with other DPSs or devices. In these examples, the communications unit 20 is a network interface card. The communications unit 20 may provide communications through the use of either or both physical and wireless communications links.

The input/output unit 22 may allow for input and output of data with other devices that may be connected to the DPS 10. For example, the input/output unit 22 may provide a connection for user input through a keyboard, a mouse, and/or some other suitable input device. Further, the input/output unit 22 may send output to a printer. The display 24 may provide a mechanism to display information to a user.

Instructions for the operating system, applications and/or programs may be located in the storage devices 26, which are in communication with the processor unit 14 through the communications bus 12. In these illustrative examples, the instructions are in a functional form on the persistent storage 18. These instructions may be loaded into the memory 16 for execution by the processor unit 14. The processes of the different embodiments may be performed by the processor unit 14 using computer implemented instructions, which may be located in a memory, such as the memory 16. These instructions are referred to as program code 38 (described below) computer usable program code, or computer readable program code that may be read and executed by a processor in the processor unit 14. The program code in the different embodiments may be embodied on different physical or tangible computer readable media, such as the memory 16 or the persistent storage 18.

The DPS 10 may further comprise an interface for a network 29. The interface may include hardware, drivers, software, and the like to allow communications over wired and wireless networks 29 and may implement any number of communication protocols, including those, for example, at various levels of the Open Systems Interconnection (OSI) seven layer model.

FIG. 1A further illustrates a computer program product 30 that may contain the program code 38. The program code 38 may be located in a functional form on the computer readable media 32 that is selectively removable and may be loaded onto or transferred to the DPS 10 for execution by the processor unit 14. The program code 38 and computer readable media 32 may form a computer program product 30 in these examples. In one example, the computer readable media 32 may be computer readable storage media 34 or computer readable signal media 36. Computer readable storage media 34 may include, for example, an optical or magnetic disk that is inserted or placed into a drive or other device that is part of the persistent storage 18 for transfer onto a storage device, such as a hard drive, that is part of the persistent storage 18. The computer readable storage media 34 also may take the form of a persistent storage, such as a hard drive, a thumb drive, or a flash memory, that is connected to the DPS 10. In some instances, the computer readable storage media 34 may not be removable from the DPS 10.

Alternatively, the program code 38 may be transferred to the DPS 10 using the computer readable signal media 36. The computer readable signal media 36 may be, for example, a propagated data signal containing the program code 38. For example, the computer readable signal media 36 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 38 may be downloaded over a network to the persistent storage 18 from another device or DPS through the computer readable signal media 36 for use within the DPS 10. For instance, program code stored in a computer readable storage medium in a server DPS may be downloaded over a network from the server to the DPS 10. The DPS providing the program code 38 may be a server computer, a client computer, or some other device capable of storing and transmitting the program code 38.

The different components illustrated for the DPS 10 are not meant to provide architectural limitations to the manner in which different embodiments may be implemented. The different illustrative embodiments may be implemented in a DPS including components in addition to or in place of those illustrated for the DPS 10.

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1B, illustrative cloud computing environment 52 is depicted. As shown, cloud computing environment 52 includes one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 52 to offer infrastructure, platforms and/or software as services for which a cloud consumer does not need to maintain resources on a local computing device. It is understood that the types of computing devices 54A-N shown in FIG. 1B are intended to be illustrative only and that computing nodes 50 and cloud computing environment 52 can communicate with any type of computerized device over any type of network and/or network addressable connection (e.g., using a web browser).

Referring now to FIG. 1C, a set of functional abstraction layers provided by cloud computing environment 52 (FIG. 1B) is shown. It should be understood in advance that the components, layers, and functions shown in FIG. 1C are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and expiring virtual currency processing 96.

Any of the nodes 50 in the computing environment 52 as well as the computing devices 54A-N may be a DPS 10.

### Blockchain Basic Detail

The instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in example embodiments, the application is not limited to a certain type of connection, message, and signaling.

Example embodiments provide methods, systems, components, non-transitory computer readable media, devices, and/or networks, which provide for implementing an expiration mechanism or other virtual currency usage rules on virtual currencies in blockchain networks.

In one embodiment the application utilizes a decentralized database (such as a blockchain) that is a distributed storage system, which includes multiple nodes that communicate with each other. The decentralized database includes an append-only immutable data structure resembling a distributed ledger capable of maintaining records between mutually untrusted parties. The untrusted parties are referred to herein as peers or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency. In various embodiments, a permissioned and/or a permissionless blockchain can be used. In a public or permissionless blockchain, anyone can participate without a specific identity. Public blockchains can involve native cryptocurrency and use consensus based on various protocols such as Proof of Work (PoW). On the other hand, a permissioned blockchain database provides secure interactions among a group of entities which share a common goal but which do not fully trust one another, such as businesses that exchange funds, goods, information, and the like.

This application can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincode to specify endorsers for a transaction in the form of a set of peer nodes that are necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

This application can utilize nodes that are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node). Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

This application can utilize a ledger that is a sequenced, tamper-resistant record of all state transitions of a blockchain. State transitions may result from chaincode invocations (i.e., transactions) submitted by participating parties (e.g., client nodes, ordering nodes, endorser nodes, peer nodes, etc.). Each participating party (such as a peer node) can maintain a copy of the ledger. A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain.

This application can utilize a chain that is a transaction log which is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

Some benefits of the instant solutions described and depicted herein include a method and system for using expiring virtual currencies or virtual currencies subject to virtual currency usage rules in blockchain networks in blockchain networks. The example embodiments solve the issues of time and trust by extending features of a database such as immutability, digital signatures and being a single source of truth. The example embodiments provide a solution for a privacy-preserving attribute-based document sharing in blockchain networks in blockchain-based network. The blockchain networks may be homogenous based on the asset type and rules that govern the assets based on the smart contracts.

Blockchain is different from a traditional database in that blockchain is not a central storage, but rather a decentralized, immutable, and secure storage, where nodes must share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, the system for a privacy-preserving attribute-based document sharing in blockchain networks in blockchain networks is implemented due to immutable accountability, security, privacy, permitted decentralization, availability of smart contracts, endorsements and accessibility that are inherent and unique to blockchain. In particular, the blockchain ledger data is immutable and that provides for efficient method for an expiring virtual currency or a virtual currency subject to virtual currency usage rules in blockchain networks in blockchain networks. Also, use of the encryption in the blockchain provides security and builds trust. The smart contract manages the state of the asset to complete the life-cycle. The example blockchains are permission decentralized. Thus, each end user may have its own ledger copy to access. Multiple organizations (and peers) may be on-boarded on the blockchain network. The key organizations may serve as endorsing peers to validate the smart contract execution results, read-set and write-set. In other words, the blockchain inherent features provide for efficient implementation of a method for an expiring virtual currency or virtual currency subject to virtual currency usage rules in blockchain networks.

One of the benefits of the example embodiments is that it improves the functionality of a computing system by implementing a method for expiring virtual currency or virtual currency subject to virtual currency usage rules in blockchain-based systems. Through the blockchain system described herein, a computing system can perform functionality for a privacy-preserving attribute-based document sharing in blockchain networks in blockchain networks by providing access to capabilities such as distributed ledger, peers, encryption technologies, MSP, event handling, etc. Also, the blockchain enables to create a business network and make any users or organizations to on-board for participation. As such, the blockchain is not just a database. The blockchain comes with capabilities to create a Business Network of users and on-board/off-board organizations to collaborate and execute service processes in the form of smart contracts.

The example embodiments provide numerous benefits over a traditional database. For example, through the blockchain the embodiments provide for immutable accountability, security, privacy, permitted decentralization, availability of smart contracts, endorsements and accessibility that are inherent and unique to the blockchain.

Meanwhile, a traditional database could not be used to implement the example embodiments because it does not bring all parties on the business network, it does not create trusted collaboration and does not provide for an efficient storage of digital assets. The traditional database does not provide for a tamper proof storage and does not provide for preservation of the digital assets being stored. Thus, the proposed method for expiring virtual currency or virtual currency subject to virtual currency usage rules in blockchain networks cannot be implemented in the traditional database.

Meanwhile, if a traditional database were to be used to implement the example embodiments, the example embodiments would have suffered from unnecessary drawbacks such as search capability, lack of security and slow speed of transactions. Additionally, the automated method for an expiring virtual currency implementation sharing in a blockchain network would simply not be possible.

Accordingly, the example embodiments provide for a specific solution to a problem in the arts/field of virtual currencies that are subject to usage rules.

The example embodiments also change how data may be stored within a block structure of the blockchain. For example, a digital asset data may be securely stored within a certain portion of the data block (i.e., within header, data segment, or metadata). By storing the digital asset data within data blocks of a blockchain, the digital asset data may be appended to an immutable blockchain ledger through a hash-linked chain of blocks. In some embodiments, the data block may be different than a traditional data block by having a personal data associated with the digital asset not stored together with the assets within a traditional block structure of a blockchain. By removing the personal data associated with the digital asset, the blockchain can provide the benefit of anonymity based on immutable accountability and security.

According to the example embodiments, a system and method for expiring virtual currency or virtual currency subject to virtual currency usage rules in blockchain networks are provided. A blockchain document processor may have two components:
a private off-chain processor that manages secure processing of private information related to a participant; and
a ledger processor that manages processing of common information shared with all participants of a blockchain network using the consensus algorithm of the network.

According to the example embodiments, each of the organizations that intend to share documents with other organizations uses a blockchain document processor connected to a blockchain network. Using the document processor, the organizations may set up the following on the ledger:
a list of document templates;
attributes of each document template that will be shared in hashed form on the ledger;
a combination of key attributes from different templates for matching and sharing documents; and
partnership Merkel trees: each partnership Merkel tree may be built based on partnering organizations' identifiers (IDs).

All documents (files, JSONs) are stored on the off-chain data store. Only the attribute hashes and the document identifier (ID) are submitted as a part of a blockchain transaction.

According to one example embodiment, a document identifier and a document type may be linked to hashed attributes for sharing. Hashed owner's organization id may include composite keys such that:
given the document ID, a document processor may get all hashed attributes for sharing; and
given a hashed attribute for sharing, the document processor may get all document IDs and their hashed owner organization id.

When a document is recorded and given its hashed attributes for sharing, the document processor may get all the documents and their hashed owner organization IDs. The processor may check if incoming document owner organization ID and each owner organization IDs are part of a partnership Merkel tree. If the IDs belong to the partnership Merkel tree for the subset of documents within an eligible organization relationship, the processor may get the required templates for logic matching. Based on evaluating the hashed attribute matching, the processor may get the list of documents (and their owners) to which the incoming document needs to be linked. Then, the processor may create the linked documents. The processor may generate a one-time pass code so that the participants can link to this document and pass it through all participants. The participants may then query the blockchain with the one-time pass code and hashed organization ID to retrieve the incoming document key. Using the document key, the participant may retrieve the shared document from the owning party (i.e., a blockchain node) and store the document on the recipient's off-chain storage.

FIG. 1D illustrates a logic network diagram for expiring virtual currency or virtual currency subject to virtual currency usage rules in blockchain networks, according to example embodiments.

Referring to FIG. 1D, the example network 100 includes a document processor node 102 connected to other blockchain (BC) nodes 105 representing document owner organizations. The document processor node 102 may be connected to a blockchain 106 that has a ledger 108 for storing data to be shared (110) among the nodes 105. While this example describes in detail only one document processor node 102, multiple such nodes may be connected to the blockchain 106. It should be understood that the document processor node 102 may include additional components and that some of the components described herein may be removed and/or modified without departing from a scope of the document processor node 102 disclosed herein. The document processor node 102 may be a computing device or a server computer, or the like, and may include a processor 104, which may be a semiconductor-based microprocessor, a central processing unit (CPU), an application specific integrated circuit (ASIC), a field-programmable gate array (FPGA), and/or another hardware device. Although a single processor 104 is depicted, it should be understood that the document processor node 102 may include multiple processors, multiple cores, or the like, without departing from the scope of the document processor node 102 system.

The document processor node 102 may also include a non-transitory computer readable medium 112 that may have stored thereon machine-readable instructions executable by the processor 104. Examples of the machine-readable instructions are shown as 114-120 and are further discussed below. Examples of the non-transitory computer readable medium 112 may include an electronic, magnetic, optical, or other physical storage device that contains or stores executable instructions. For example, the non-transitory computer readable medium 112 may be a Random Access memory (RAM), an Electrically Erasable Programmable Read-Only Memory (EEPROM), a hard disk, an optical disc, or other type of storage device.

In some embodiments, the processor 104 may execute first machine-readable instructions 114 to retrieve an EVC transaction associated with a blockchain and addressed to an address associated with an EVC wallet, the EVC transaction comprising an expiration date for the EVCs, the EVCs being subject to virtual currency user rules (VCURs) of which the expiration date is a part of. As discussed above, the blockchain ledger 108 may store data to be shared among the nodes 105. The blockchain 106 network may be configured to use one or more smart contracts that manage transactions for multiple participating nodes. The processor 104 may execute second machine-readable instructions 116 to determine whether the expiration date of the EVCs in the EVC transaction has passed. The processor 104 may execute third machine-readable instructions 118 to, based on a first condition that the expiration date has passed, automatically, and without user intervention, transfer the EVCs to a transferee designated in the VCURs

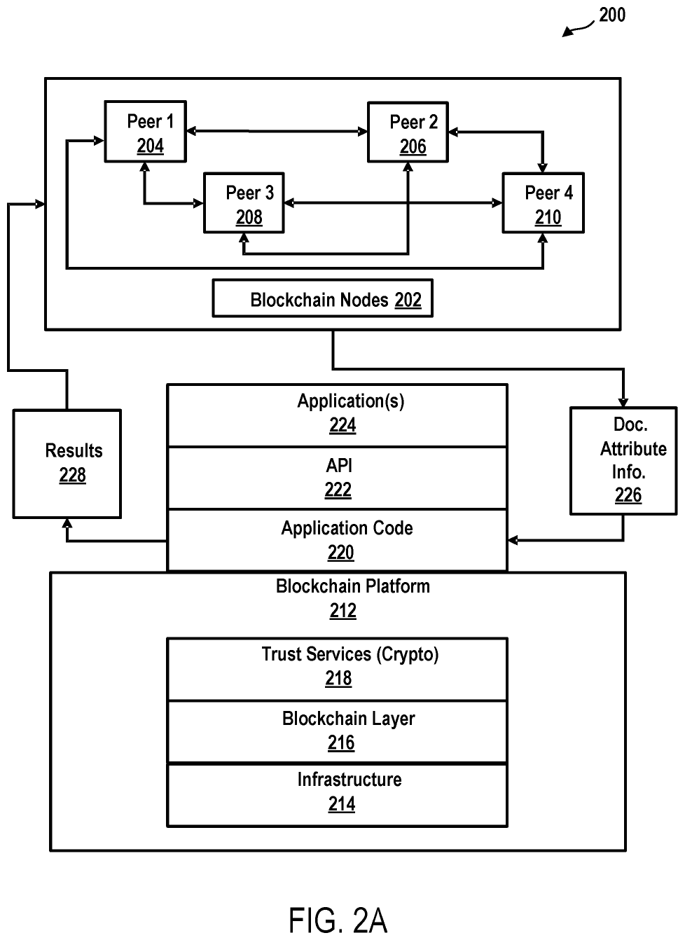

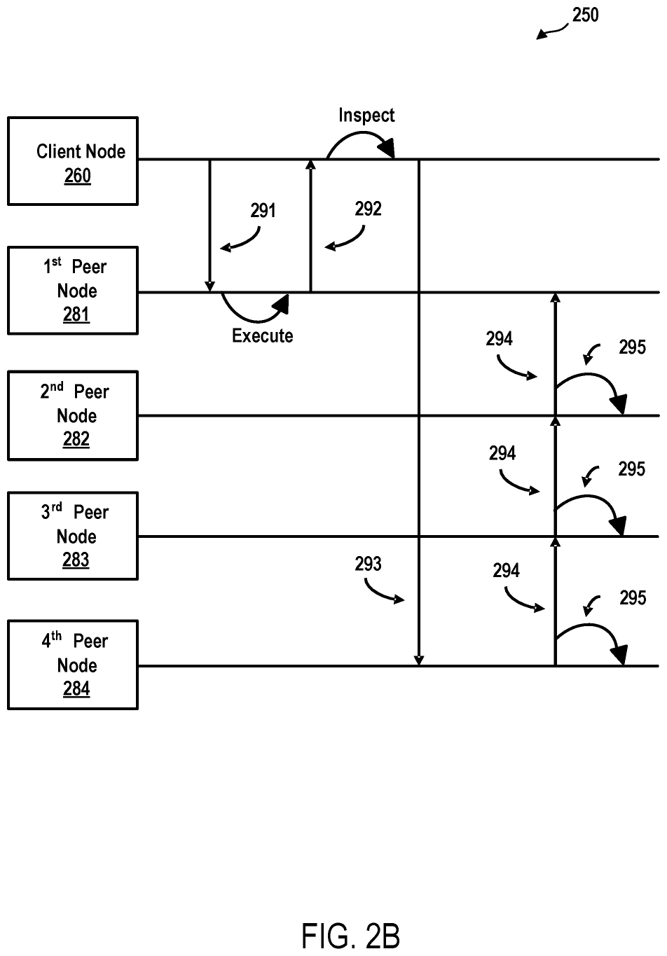

FIG. 2A illustrates a blockchain architecture configuration 200, according to example embodiments. Referring to FIG. 2A, the blockchain architecture 200 may include certain blockchain elements, for example, a group of blockchain nodes 202. The blockchain nodes 202 may include one or more nodes 204-210 (these four nodes are depicted by example only). These nodes participate in a number of activities, such as blockchain transaction addition and validation process (consensus). One or more of the blockchain nodes 204-210 may endorse transactions based on endorsement policy and may provide an ordering service for all blockchain nodes in the architecture 200. A blockchain node may initiate a blockchain authentication and seek to write to a blockchain immutable ledger stored in blockchain layer 216, a copy of which may also be stored on the underpinning physical infrastructure 214. The blockchain configuration may include one or more applications 224 which are linked to application programming interfaces (APIs) 222 to access and execute stored program/application code 220 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2A may process and execute program/application code 220 via one or more interfaces exposed, and services provided, by blockchain platform 212. The code 220 may control blockchain assets. For example, the code 220 can store and transfer data, and may be executed by nodes 204-210 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, the document attribute(s) information 226 may be processed by one or more processing entities (e.g., virtual machines) included in the blockchain layer 216. The result 228 may include a plurality of linked shared documents. The physical infrastructure 214 may be utilized to retrieve any of the data or information described herein.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details.

FIG. 2B illustrates an example of a blockchain transactional flow 250 between nodes of the blockchain in accordance with an example embodiment. Referring to FIG. 2B, the transaction flow may include a transaction proposal 291 sent by an application client node 260 to an endorsing peer node 281. The endorsing peer 281 may verify the client signature and execute a chaincode function to initiate the transaction. The output may include the chaincode results, a set of key/value versions that were read in the chaincode (read set), and the set of keys/values that were written in chaincode (write set). The proposal response 292 is sent back to the client 260 along with an endorsement signature, if approved. The client 260 assembles the endorsements into a transaction payload 293 and broadcasts it to an ordering service node 284. The ordering service node 284 then delivers ordered transactions as blocks to all peers 281-283 on a channel. Before committal to the blockchain, each peer 281-283 may validate the transaction. For example, the peers may check the endorsement policy to ensure that the correct allotment of the specified peers have signed the results and authenticated the signatures against the transaction payload 293.

Referring again to FIG. 2B, the client node 260 initiates the transaction 291 by constructing and sending a request to the peer node 281, which is an endorser. The client 260 may include an application leveraging a supported software development kit (SDK), which utilizes an available API to generate a transaction proposal. The proposal is a request to invoke a chaincode function so that data can be read and/or written to the ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 281 may verify (a) that the transaction proposal is well formed, (b) the transaction has not been submitted already in the past (replay-attack protection), (c) the signature is valid, and (d) that the submitter (client 260, in the example) is properly authorized to perform the proposed operation on that channel. The endorsing peer node 281 may take the transaction proposal inputs as arguments to the invoked chaincode function. The chaincode is then executed against a current state database to produce transaction results including a response value, read set, and write set. However, no updates are made to the ledger at this point. In 292, the set of values, along with the endorsing peer node's 281 signature is passed back as a proposal response 292 to the SDK of the client 260 which parses the payload for the application to consume.

In response, the application of the client 260 inspects/verifies the endorsing peers signatures and compares the proposal responses to determine if the proposal response is the same. If the chaincode only queried the ledger, the application would inspect the query response and would typically not submit the transaction to the ordering node service 284. If the client application intends to submit the transaction to the ordering node service 284 to update the ledger, the application determines if the specified endorsement policy has been fulfilled before submitting (i.e., did all peer nodes necessary for the transaction endorse the transaction). Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in step 293 the client 260 assembles endorsements into a transaction and broadcasts the transaction proposal and response within a transaction message to the ordering node 284. The transaction may contain the read/write sets, the endorsing peers signatures and a channel ID. The ordering node 284 does not need to inspect the entire content of a transaction in order to perform its operation, instead the ordering node 284 may simply receive transactions from all channels in the network, order them chronologically by channel, and create blocks of transactions per channel.

The blocks of the transaction are delivered from the ordering node 284 to all peer nodes 281-283 on the channel. The transactions 294 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 295 each peer node 281-283 appends the block to the channel's chain, and for each valid transaction the write sets are committed to current state database. An event is emitted, to notify the client application that the transaction (invocation) has been immutably appended to the chain, as well as to notify whether the transaction was validated or invalidated.

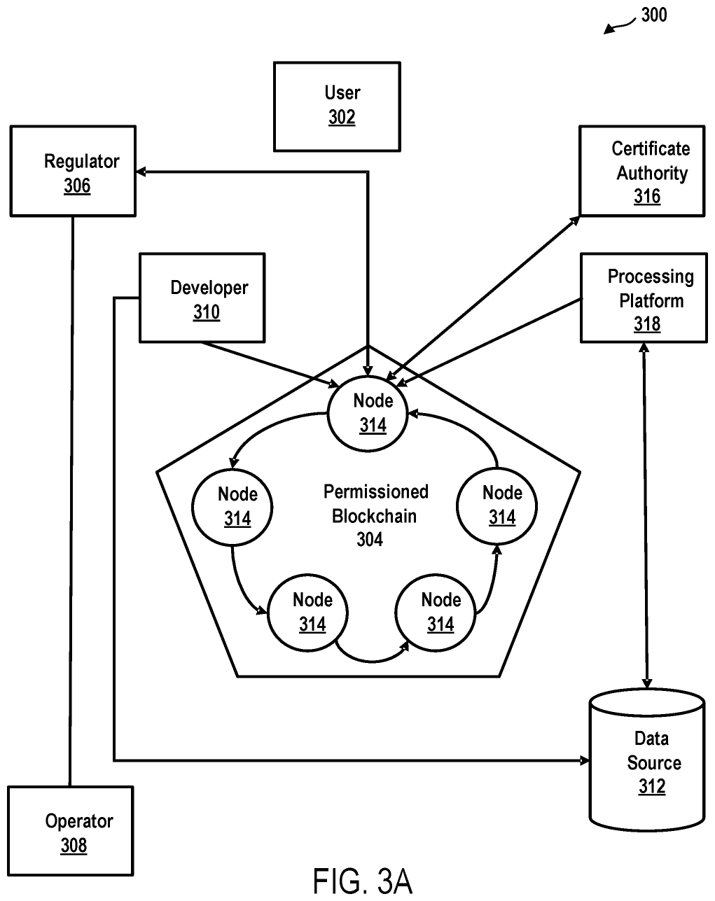

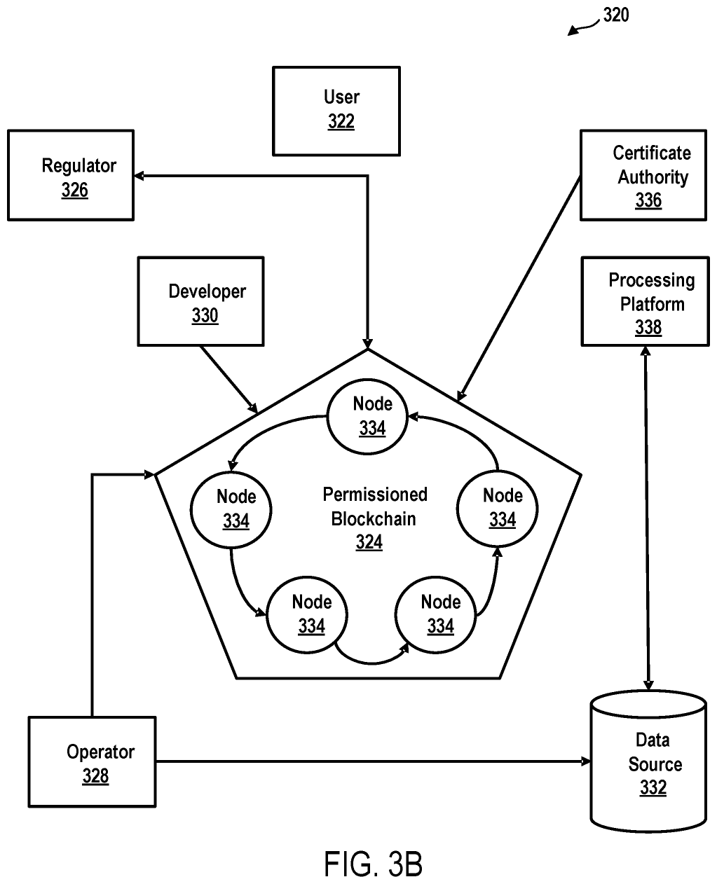

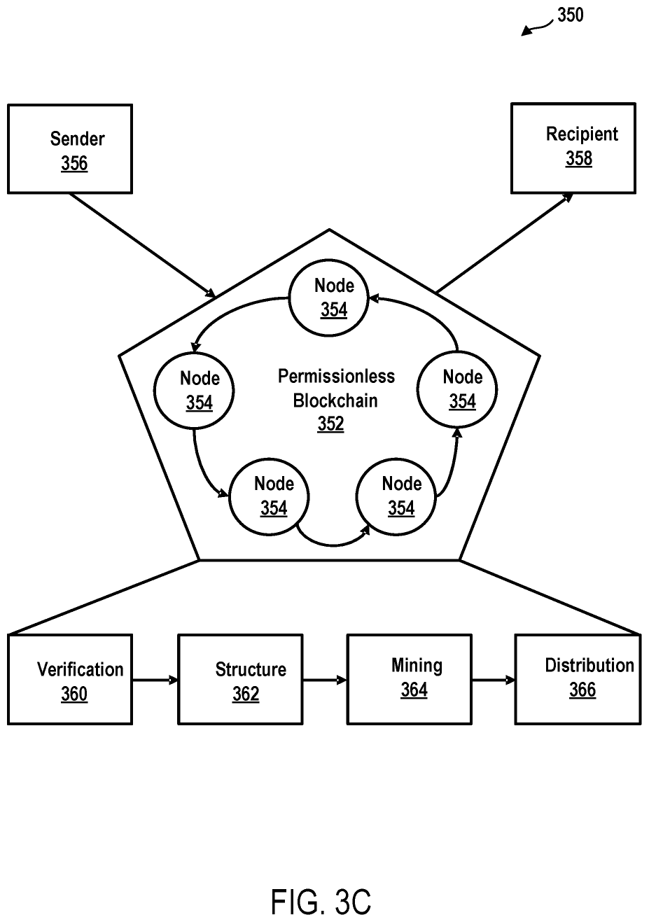

FIG. 3A illustrates an example of a permissioned blockchain network 300, which features a distributed, decentralized peer-to-peer architecture. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client”. An auditor could be restricted only to querying the ledger whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client.” An auditor could be restricted only to querying the ledger whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining protocols to help verify transactions.

FIG. 3C illustrates a process 350 of a transaction being processed by a permissionless blockchain 352 including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters the nodes verify 360 the transaction based on rules (which may be pre-defined or dynamically allocated) established by the permissionless blockchain 352 creators. For example, this may include verifying identities of the parties involved, etc. The transaction may be verified immediately or it may be placed in a queue with other transactions and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256 bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution 366, the successfully validated block is distributed through the permissionless blockchain 352 and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

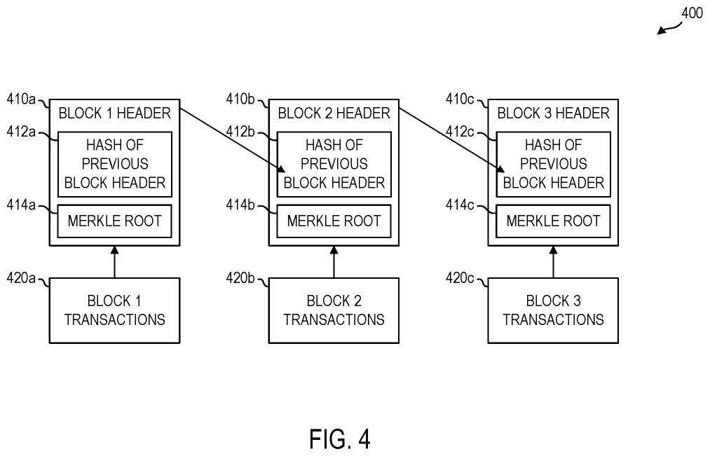

FIG. 4 is a block diagram that illustrates a basic blockchain sequence 400 of three transactions. The first block contains a first header 410a and a first group of transactions 420a making up the first block. The block header contains a hash 412a of the previous block header and a Merkle root 414a. The Merkle root 414a is a hash of all the hashes of all the transactions that are part of a block in a blockchain network that ensures data blocks passed between peers are whole, undamaged, and unaltered. The second block contains a second header 410b and a second group of transactions 420b making up the second block. The block header contains a hash 412b of the previous block header 410a and a Merkle root 414b. The third block contains a third header 410c and a third group of transactions 420c making up the third block. The block header contains a hash 412c of the previous block header 410b and a Merkle root 414c. The number of blocks may be extended to any feasible length and hash values may be checked/verified with relative ease.

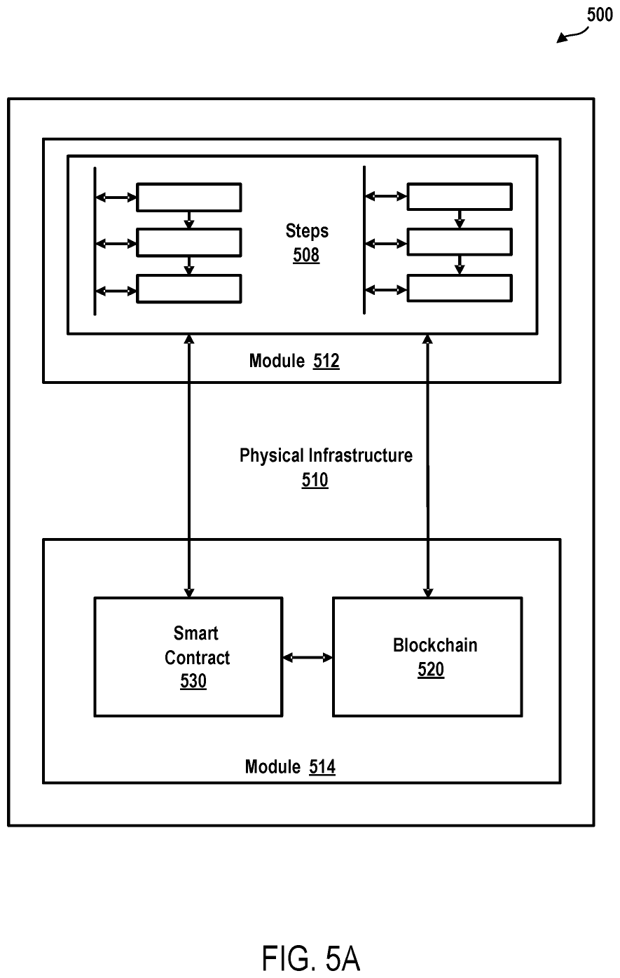

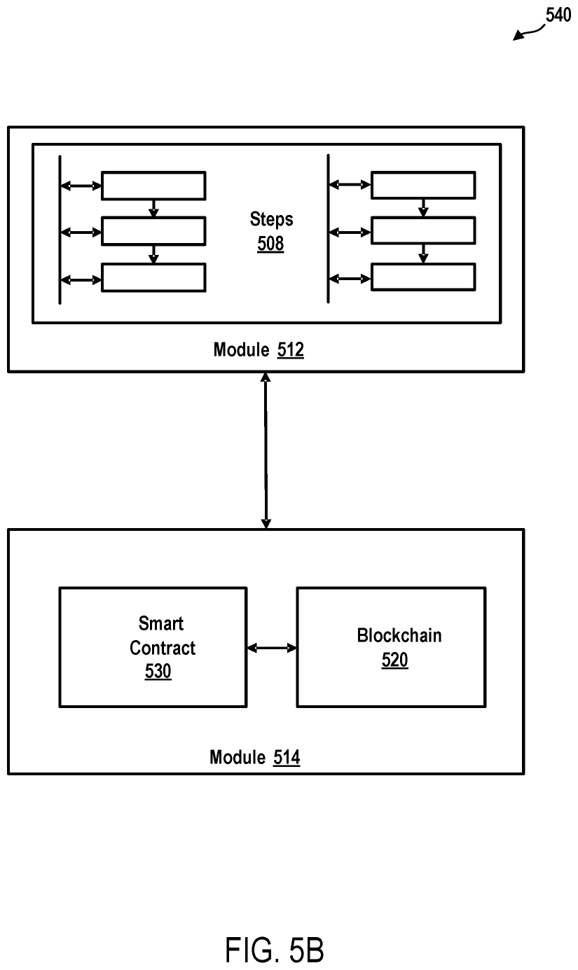

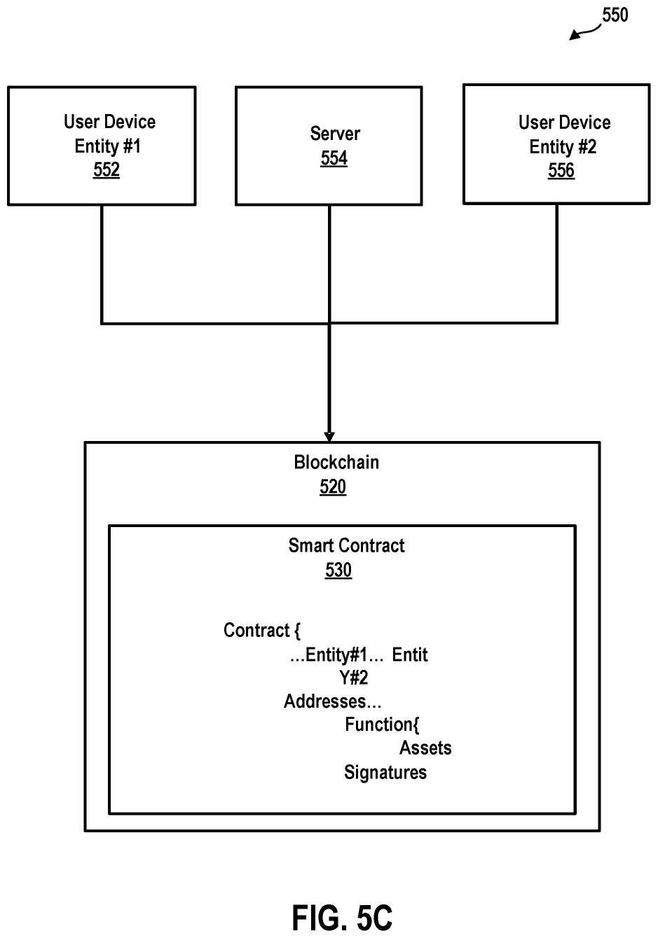

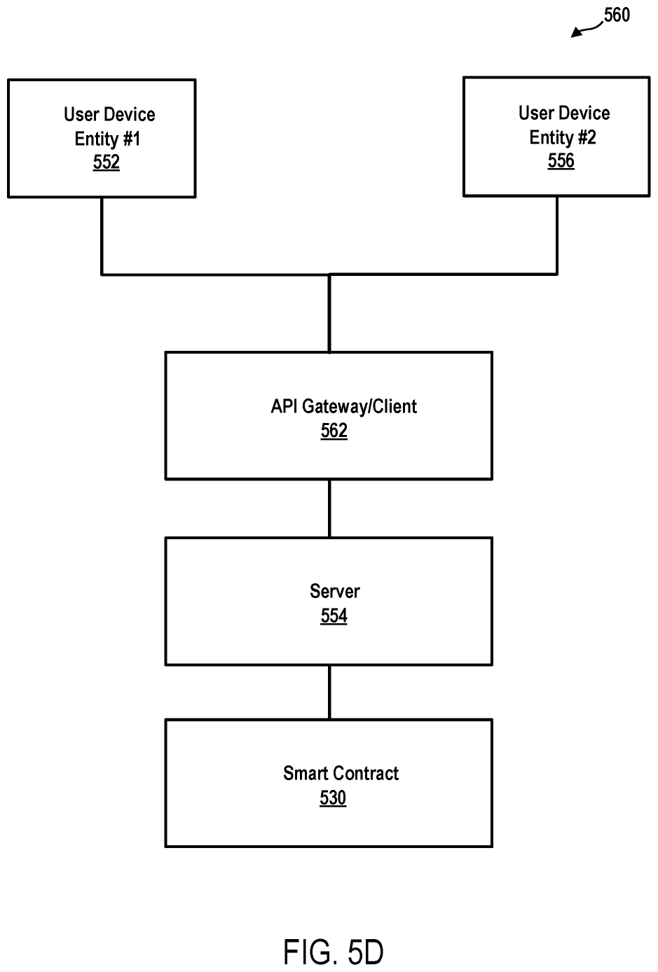

FIG. 5A illustrates an example system 500 that includes a physical infrastructure 510 configured to perform various operations according to example embodiments. Referring to FIG. 5A, the physical infrastructure 510 includes a module 512 and a module 514. The module 514 includes a blockchain 520 and a smart contract 530 (which may reside on the blockchain 520), that may execute any of the operational steps 508 (in module 512) included in any of the example embodiments. The steps/operations 508 may include one or more of the embodiments described or depicted and may represent output or written information that is written or read from one or more smart contracts 530 and/or blockchains 520. The physical infrastructure 510, the module 512, and the module 514 may include one or more computers, servers, processors, memories, and/or wireless communication devices. Further, the module 512 and the module 514 may be a same module.

FIG. 5B illustrates another example system 540 configured to perform various operations according to example embodiments. Referring to FIG. 5B, the system 540 includes a module 512 and a module 514. The module 514 includes a blockchain 520 and a smart contract 530 (which may reside on the blockchain 520), that may execute any of the operational steps 508 (in module 512) included in any of the example embodiments. The steps/operations 508 may include one or more of the embodiments described or depicted and may represent output or written information that is written or read from one or more smart contracts 530 and/or blockchains 520. The physical module 512 and the module 514 may include one or more computers, servers, processors, memories, and/or wireless communication devices. Further, the module 512 and the module 514 may be a same module.

FIG. 5C illustrates an example system configured to utilize a smart contract configuration among contracting parties and a mediating server configured to enforce the smart contract terms on the blockchain according to example embodiments. Referring to FIG. 5C, the configuration 550 may represent a communication session, an asset transfer session or a process or procedure that is driven by a smart contract 530 which explicitly identifies one or more user devices 552 and/or 556. The execution, operations and results of the smart contract execution may be managed by a server 554. Content of the smart contract 530 may require digital signatures by one or more of the entities 552 and 556 which are parties to the smart contract transaction. The results of the smart contract execution may be written to a blockchain 520 as a blockchain transaction. The smart contract 530 resides on the blockchain 520 which may reside on one or more computers, servers, processors, memories, and/or wireless communication devices.

FIG. 5D illustrates a system 560 including a blockchain, according to example embodiments. Referring to the example of FIG. 5D, an application programming interface (API) gateway 562 provides a common interface for accessing blockchain logic (e.g., smart contract 530 or other chaincode) and data (e.g., distributed ledger, etc.). In this example, the API gateway 562 is a common interface for performing transactions (invoke, queries, etc.) on the blockchain by connecting one or more entities 552 and 556 to a blockchain peer (i.e., server 554). Here, the server 554 is a blockchain network peer component that holds a copy of the world state and a distributed ledger allowing clients 552 and 556 to query data on the world state as well as submit transactions into the blockchain network where, depending on the smart contract 530 and endorsement policy, endorsing peers will run the smart contracts 530.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An example storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

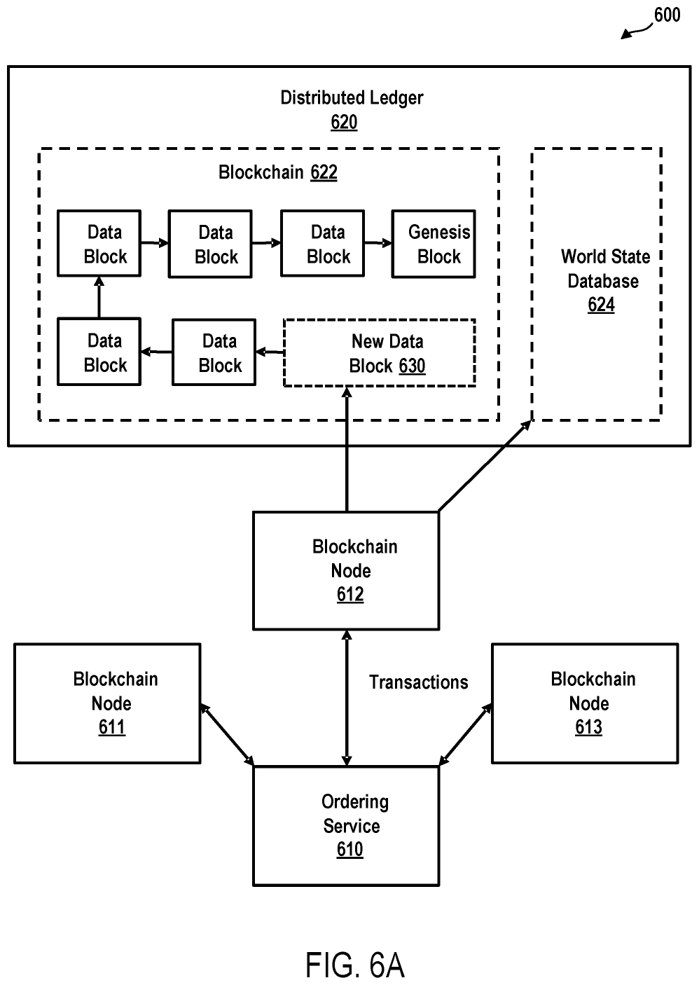

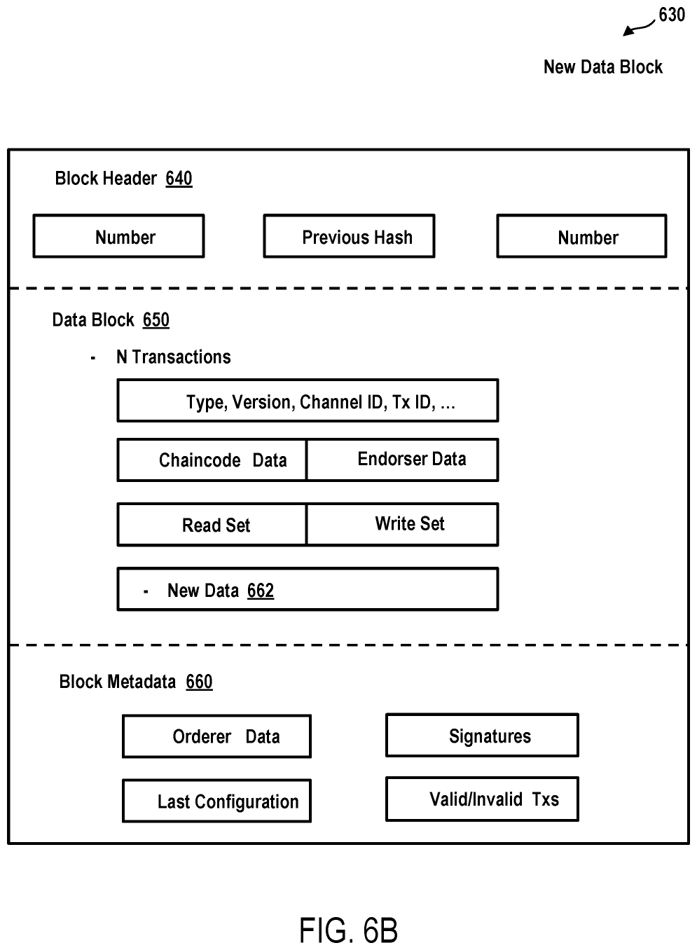

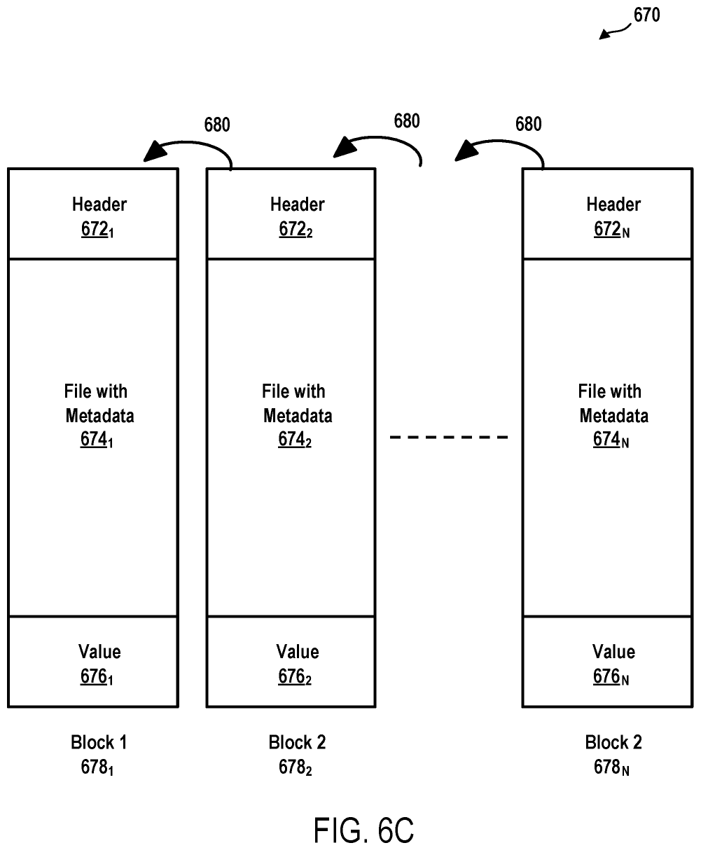

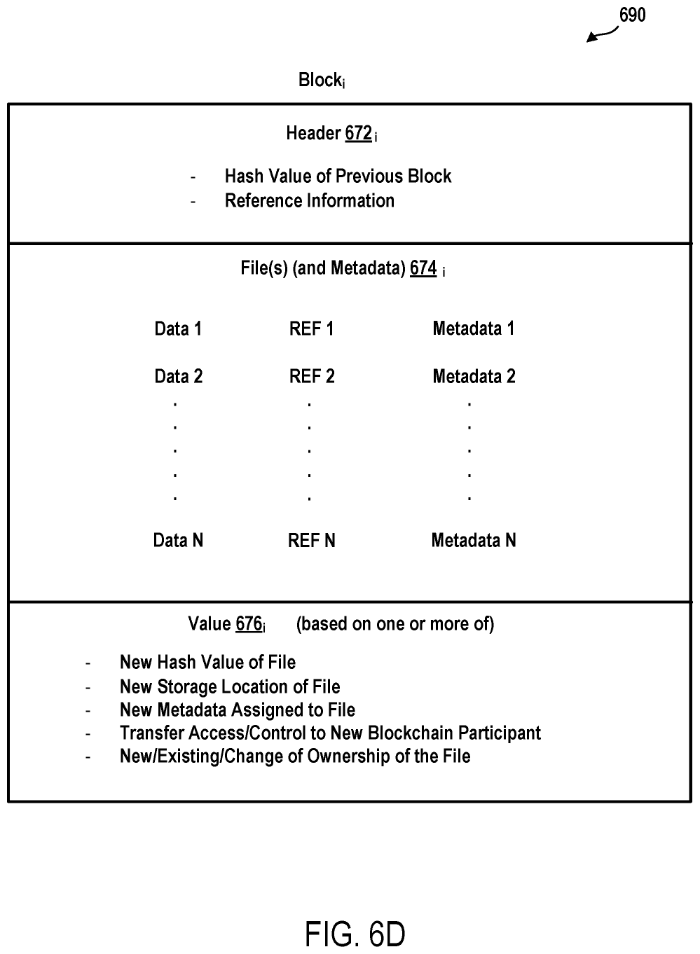

FIG. 6A illustrates a process 600 of a new block being added to a distributed ledger 620, according to example embodiments, and FIG. 6B illustrates contents of a new data block structure 630 for blockchain, according to example embodiments. The new data block 630 may contain document linking data.

Referring to FIG. 6A, clients (not shown) may submit transactions to blockchain nodes 611, 612, and/or 613. Clients may be instructions received from any source to enact activity on the blockchain 620. As an example, clients may be applications that act on behalf of a requester, such as a device, person or entity to propose transactions for the blockchain. The plurality of blockchain peers (e.g., blockchain nodes 611, 612, and 613) may maintain a state of the blockchain network and a copy of the distributed ledger 620. Different types of blockchain nodes/peers may be present in the blockchain network including endorsing peers which simulate and endorse transactions proposed by clients and committing peers which verify endorsements, validate transactions, and commit transactions to the distributed ledger 620. In this example, the blockchain nodes 611, 612, and 613 may perform the role of endorser node, committer node, or both.

The distributed ledger 620 includes a blockchain which stores immutable, sequenced records in blocks, and a state database 624 (current world state) maintaining a current state of the blockchain 622. One distributed ledger 620 may exist per channel and each peer maintains its own copy of the distributed ledger 620 for each channel of which they are a member. The blockchain 622 is a transaction log, structured as hash-linked blocks where each block contains a sequence of N transactions. Blocks may include various components such as shown in FIG. 6B. The linking of the blocks (shown by arrows in FIG. 6A) may be generated by adding a hash of a prior block's header within a block header of a current block. In this way, all transactions on the blockchain 622 are sequenced and cryptographically linked together preventing tampering with blockchain data without breaking the hash links. Furthermore, because of the links, the latest block in the blockchain 622 represents every transaction that has come before it. The blockchain 622 may be stored on a peer file system (local or attached storage), which supports an append-only blockchain workload.

The current state of the blockchain 622 and the distributed ledger 622 may be stored in the state database 624. Here, the current state data represents the latest values for all keys ever included in the chain transaction log of the blockchain 622. Chaincode invocations execute transactions against the current state in the state database 624. To make these chaincode interactions extremely efficient, the latest values of all keys are stored in the state database 624. The state database 624 may include an indexed view into the transaction log of the blockchain 622, it can therefore be regenerated from the chain at any time. The state database 624 may automatically get recovered (or generated if needed) upon peer startup, before transactions are accepted.

Endorsing nodes receive transactions from clients and endorse the transaction based on simulated results. Endorsing nodes hold smart contracts which simulate the transaction proposals. When an endorsing node endorses a transaction, the endorsing node creates a transaction endorsement which is a signed response from the endorsing node to the client application indicating the endorsement of the simulated transaction. The method of endorsing a transaction depends on an endorsement policy which may be specified within chaincode. An example of an endorsement policy is “the majority of endorsing peers must endorse the transaction”. Different channels may have different endorsement policies. Endorsed transactions are forward by the client application to ordering service 610.

The ordering service 610 accepts endorsed transactions, orders them into a block, and delivers the blocks to the committing peers. For example, the ordering service 610 may initiate a new block when a threshold of transactions has been reached, a timer times out, or another condition. In the example of FIG. 6A, blockchain node 612 is a committing peer that has received a new data new data block 630 for storage on blockchain 620. The first block in the blockchain may be referred to as a genesis block which includes information about the blockchain, its members, the data stored therein, etc.

The ordering service 610 may be made up of a cluster of orderers. The ordering service 610 does not process transactions, smart contracts, or maintain the shared ledger. Rather, the ordering service 610 may accept the endorsed transactions and specifies the order in which those transactions are committed to the distributed ledger 620. The architecture of the blockchain network may be designed such that the specific implementation of ‘ordering’ (e.g., Solo, Kafka, BFT, etc.) becomes a pluggable component.

Transactions are written to the distributed ledger 620 in a consistent order. The order of transactions is established to ensure that the updates to the state database 624 are valid when they are committed to the network. Unlike a cryptocurrency blockchain system (e.g., virtual currency, etc.) where ordering occurs through the solving of a cryptographic puzzle, or mining, in this example the parties of the distributed ledger 620 may choose the ordering mechanism that best suits that network.

When the ordering service 610 initializes a new data block 630, the new data block 630 may be broadcast to committing peers (e.g., blockchain nodes 611, 612, and 613). In response, each committing peer validates the transaction within the new data block 630 by checking to make sure that the read set and the write set still match the current world state in the state database 624. Specifically, the committing peer can determine whether the read data that existed when the endorsers simulated the transaction is identical to the current world state in the state database 624. When the committing peer validates the transaction, the transaction is written to the blockchain 622 on the distributed ledger 620, and the state database 624 is updated with the write data from the read-write set. If a transaction fails, that is, if the committing peer finds that the read-write set does not match the current world state in the state database 624, the transaction ordered into a block will still be included in that block, but it will be marked as invalid, and the state database 624 will not be updated.

Referring to FIG. 6B, a new data block 630 (also referred to as a data block) that is stored on the blockchain 622 of the distributed ledger 620 may include multiple data segments such as a block header 640, block data 650, and block metadata 660. It should be appreciated that the various depicted blocks and their contents, such as new data block 630 and its contents. Shown in FIG. 6B are merely examples and are not meant to limit the scope of the example embodiments. The new data block 630 may store transactional information of N transaction(s) (e.g., 1, 10, 100, 500, 1000, 2000, 3000, etc.) within the block data 650. The new data block 630 may also include a link to a previous block (e.g., on the blockchain 622 in FIG. 6A) within the block header 640. In particular, the block header 640 may include a hash of a previous block's header. The block header 640 may also include a unique block number, a hash of the block data 650 of the new data block 630, and the like. The block number of the new data block 630 may be unique and assigned in various orders, such as an incremental/sequential order starting from zero.

The block data 650 may store transactional information of each transaction that is recorded within the new data block 630. For example, the transaction data may include one or more of a type of the transaction, a version, a timestamp, a channel ID of the distributed ledger 620, a transaction ID, an epoch, a payload visibility, a chaincode path (deploy tx), a chaincode name, a chaincode version, input (chaincode and functions), a client (creator) identify such as a public key and certificate, a signature of the client, identities of endorsers, endorser signatures, a proposal hash, chaincode events, response status, namespace, a read set (list of key and version read by the transaction, etc.), a write set (list of key and value, etc.), a start key, an end key, a list of keys, a Merkel tree query summary, and the like. The transaction data may be stored for each of the N transactions.

In some embodiments, the block data 650 may also store new data 662 which adds additional information to the hash-linked chain of blocks in the blockchain 622. The additional information includes one or more of the steps, features, processes and/or actions described or depicted herein. Accordingly, the new data 662 can be stored in an immutable log of blocks on the distributed ledger 620. Some of the benefits of storing such new data 662 are reflected in the various embodiments disclosed and depicted herein. Although in FIG. 6B the new data 662 is depicted in the block data 650 but could also be located in the block header 640 or the block metadata 660. The new data 662 may include a document composite key that is used for linking the documents within an organization.

The block metadata 660 may store multiple fields of metadata (e.g., as a byte array, etc.). Metadata fields may include signature on block creation, a reference to a last configuration block, a transaction filter identifying valid and invalid transactions within the block, last offset persisted of an ordering service that ordered the block, and the like. The signature, the last configuration block, and the orderer metadata may be added by the ordering service 610. Meanwhile, a committer of the block (such as blockchain node 612) may add validity/invalidity information based on an endorsement policy, verification of read/write sets, and the like. The transaction filter may include a byte array of a size equal to the number of transactions in the block data 650 and a validation code identifying whether a transaction was valid/invalid.

FIG. 6C illustrates an embodiment of a blockchain 670 for digital content in accordance with the embodiments described herein. The digital content may include one or more files and associated information. The files may include media, images, video, audio, text, links, graphics, animations, web pages, documents, or other forms of digital content. The immutable, append-only aspects of the blockchain serve as a safeguard to protect the integrity, validity, and authenticity of the digital content, making it suitable use in legal proceedings where admissibility rules apply or other settings where evidence is taken in to consideration or where the presentation and use of digital information is otherwise of interest. In this case, the digital content may be referred to as digital evidence.

The blockchain may be formed in various ways. In one embodiment, the digital content may be included in and accessed from the blockchain itself. For example, each block of the blockchain may store a hash value of reference information (e.g., header, value, etc.) along the associated digital content. The hash value and associated digital content may then be encrypted together. Thus, the digital content of each block may be accessed by decrypting each block in the blockchain, and the hash value of each block may be used as a basis to reference a previous block. This may be illustrated as follows:

| | | | |
|---|---|---|---|
| Block 1 | Block 2 | . . . | Block N |

| | | |
|---|---|---|
| Hash Value 1 | Hash Value 2 | Hash Value N |
| Digital Content 1 | Digital Content 2 | Digital Content N |

In one embodiment, the digital content may be not included in the blockchain. For example, the blockchain may store the encrypted hashes of the content of each block without any of the digital content. The digital content may be stored in another storage area or memory address in association with the hash value of the original file. The other storage area may be the same storage device used to store the blockchain or may be a different storage area or even a separate relational database. The digital content of each block may be referenced or accessed by obtaining or querying the hash value of a block of interest and then looking up that has value in the storage area, which is stored in correspondence with the actual digital content. This operation may be performed, for example, a database gatekeeper. This may be illustrated as follows:

| Blockchain | Storage Area |
|---|---|
| Block 1 Hash Value | Block 1 Hash Value . . . Content |
| . | . |
| . | . |
| . | . |
| Block N Hash Value | Block N Hash Value . . . Content |

In the example embodiment of FIG. 6C, the blockchain 670 includes a number of blocks 678₁, 678₂, . . . 678_{N} cryptographically linked in an ordered sequence, where N≥1. The encryption used to link the blocks 678₁, 678₂, . . . 678_{N} may be any of a number of keyed or un-keyed Hash functions. In one embodiment, the blocks 678₁, 678₂, . . . 678_{N} are subject to a hash function which produces n-bit alphanumeric outputs (where n is 256 or another number) from inputs that are based on information in the blocks. Examples of such a hash function include, but are not limited to, a SHA-type (SHA stands for Secured Hash Algorithm) algorithm, Merkle-Damgard algorithm, HAIFA algorithm, Merkle-tree algorithm, nonce-based algorithm, and a non-collision-resistant PRF algorithm. In another embodiment, the blocks 678₁, 678₂, . . . , 678_{N} may be cryptographically linked by a function that is different from a hash function. For purposes of illustration, the following description is made with reference to a hash function, e.g., SHA-2.

Each of the blocks 678₁, 678₂, . . . , 678_{N} in the blockchain includes a header, a version of the file, and a value. The header and the value are different for each block as a result of hashing in the blockchain. In one embodiment, the value may be included in the header. As described in greater detail below, the version of the file may be the original file or a different version of the original file.

The first block 678₁ in the blockchain is referred to as the genesis block and includes the header 672₁, original file 674₁, and an initial value 676₁. The hashing scheme used for the genesis block, and indeed in all subsequent blocks, may vary. For example, all the information in the first block 678₁ may be hashed together and at one time, or each or a portion of the information in the first block 678₁ may be separately hashed and then a hash of the separately hashed portions may be performed.

The header 672₁ may include one or more initial parameters, which, for example, may include a version number, timestamp, nonce, root information, difficulty level, consensus protocol, duration, media format, source, descriptive keywords, and/or other information associated with original file 674₁ and/or the blockchain. The header 672₁ may be generated automatically (e.g., by blockchain network managing software) or manually by a blockchain participant. Unlike the header in other blocks 678₂ to 678_{N} in the blockchain, the header 672₁ in the genesis block does not reference a previous block, simply because there is no previous block.

The original file 674₁ in the genesis block may be, for example, data as captured by a device with or without processing prior to its inclusion in the blockchain. The original file 674₁ is received through the interface of the system from the device, media source, or node. The original file 674₁ is associated with metadata, which, for example, may be generated by a user, the device, and/or the system processor, either manually or automatically. The metadata may be included in the first block 678₁ in association with the original file 674₁.

The value 676₁ in the genesis block is an initial value generated based on one or more unique attributes of the original file 674₁. In one embodiment, the one or more unique attributes may include the hash value for the original file 674₁, metadata for the original file 674₁, and other information associated with the file. In one implementation, the initial value 676₁ may be based on the following unique attributes:
1) SHA-2 computed hash value for the original file
2) originating device ID
3) starting timestamp for the original file
4) initial storage location of the original file
5) blockchain network member ID for software to currently control the original file and associated metadata

The other blocks 678₂ to 678_{N} in the blockchain also have headers, files, and values. However, unlike the first block 672₁, each of the headers 672₂ to 672_{N} in the other blocks includes the hash value of an immediately preceding block. The hash value of the immediately preceding block may be just the hash of the header of the previous block or may be the hash value of the entire previous block. By including the hash value of a preceding block in each of the remaining blocks, a trace can be performed from the Nth block back to the genesis block (and the associated original file) on a block-by-block basis, as indicated by arrows 680, to establish an auditable and immutable chain-of-custody.

Each of the header 672₂ to 672_{N} in the other blocks may also include other information, e.g., version number, timestamp, nonce, root information, difficulty level, consensus protocol, and/or other parameters or information associated with the corresponding files and/or the blockchain in general.

The files 674₂ to 674_{N} in the other blocks may be equal to the original file or may be a modified version of the original file in the genesis block depending, for example, on the type of processing performed. The type of processing performed may vary from block to block. The processing may involve, for example, any modification of a file in a preceding block, such as redacting information or otherwise changing the content of, taking information away from, or adding or appending information to the files.

Additionally, or alternatively, the processing may involve merely copying the file from a preceding block, changing a storage location of the file, analyzing the file from one or more preceding blocks, moving the file from one storage or memory location to another, or performing action relative to the file of the blockchain and/or its associated metadata. Processing which involves analyzing a file may include, for example, appending, including, or otherwise associating various analytics, statistics, or other information associated with the file.

The values in each of the other blocks 676₂ to 676_{N} in the other blocks are unique values and are all different as a result of the processing performed. For example, the value in any one block corresponds to an updated version of the value in the previous block. The update is reflected in the hash of the block to which the value is assigned. The values of the blocks therefore provide an indication of what processing was performed in the blocks and also permit a tracing through the blockchain back to the original file. This tracking confirms the chain-of-custody of the file throughout the entire blockchain.

For example, consider the case where portions of the file in a previous block are redacted, blocked out, or pixelated in order to protect the identity of a person shown in the file. In this case, the block including the redacted file will include metadata associated with the redacted file, e.g., how the redaction was performed, who performed the redaction, timestamps where the redaction(s) occurred, etc. The metadata may be hashed to form the value. Because the metadata for the block is different from the information that was hashed to form the value in the previous block, the values are different from one another and may be recovered when decrypted.

In one embodiment, the value of a previous block may be updated (e.g., a new hash value computed) to form the value of a current block when any one or more of the following occurs. The new hash value may be computed by hashing all or a portion of the information noted below, in this example embodiment.
a) new SHA-2 computed hash value if the file has been processed in any way (e.g., if the file was redacted, copied, altered, accessed, or some other action was taken)
b) new storage location for the file
c) new metadata identified associated with the file
d) transfer of access or control of the file from one blockchain participant to another blockchain participant

FIG. 6D illustrates an embodiment of a block which may represent the structure of the blocks in the blockchain 690 in accordance with one embodiment. The block, Blockᵢ, includes a header 672ᵢ, a file 674ᵢ, and a value 676ᵢ.

The header 672ᵢ includes a hash value of a previous block Blockᵢ₋₁ and additional reference information, which, for example, may be any of the types of information (e.g., header information including references, characteristics, parameters, etc.) discussed herein. All blocks reference the hash of a previous block except, of course, the genesis block. The hash value of the previous block may be just a hash of the header in the previous block or a hash of all or a portion of the information in the previous block, including the file and metadata.

The file 674ᵢ includes a plurality of data, such as Data 1, Data 2, . . . , Data N in sequence. The data are tagged with Metadata 1, Metadata 2, . . . , Metadata N which describe the content and/or characteristics associated with the data. For example, the metadata for each data may include information to indicate a timestamp for the data, process the data, keywords indicating the persons or other content depicted in the data, and/or other features that may be helpful to establish the validity and content of the file as a whole, and particularly its use a digital evidence, for example, as described in connection with an embodiment discussed below. In addition to the metadata, each data may be tagged with reference REF₁, REF₂, . . . , REF_{N} to a previous data to prevent tampering, gaps in the file, and sequential reference through the file.

Once the metadata is assigned to the data (e.g., through a smart contract), the metadata cannot be altered without the hash changing, which can easily be identified for invalidation. The metadata, thus, creates a data log of information that may be accessed for use by participants in the blockchain.

The value 676ᵢ is a hash value or other value computed based on any of the types of information previously discussed. For example, for any given block Blockᵢ the value for that block may be updated to reflect the processing that was performed for that block, e.g., new hash value, new storage location, new metadata for the associated file, transfer of control or access, identifier, or other action or information to be added. Although the value in each block is shown to be separate from the metadata for the data of the file and header, the value may be based, in part or whole, on this metadata in another embodiment.

Once the blockchain 670 is formed, at any point in time, the immutable chain-of-custody for the file may be obtained by querying the blockchain for the transaction history of the values across the blocks. This query, or tracking procedure, may begin with decrypting the value of the block that is most currently included (e.g., the last (N^{th}) block), and then continuing to decrypt the value of the other blocks until the genesis block is reached and the original file is recovered. The decryption may involve decrypting the headers and files and associated metadata at each block, as well.

Decryption is performed based on the type of encryption that took place in each block. This may involve the use of private keys, public keys, or a public key-private key pair. For example, when asymmetric encryption is used, blockchain participants or a processor in the network may generate a public key and private key pair using a predetermined algorithm. The public key and private key are associated with each other through some mathematical relationship. The public key may be distributed publicly to serve as an address to receive messages from other users, e.g., an IP address or home address. The private key is kept secret and used to digitally sign messages sent to other blockchain participants. The signature is included in the message so that the recipient can verify using the public key of the sender. This way, the recipient can be sure that only the sender could have sent this message.

Generating a key pair may be analogous to creating an account on the blockchain, but without having to actually register anywhere. Also, every transaction that is executed on the blockchain is digitally signed by the sender using their private key. This signature ensures that only the owner of the account can track and process (if within the scope of permission determined by a smart contract) the file of the blockchain.

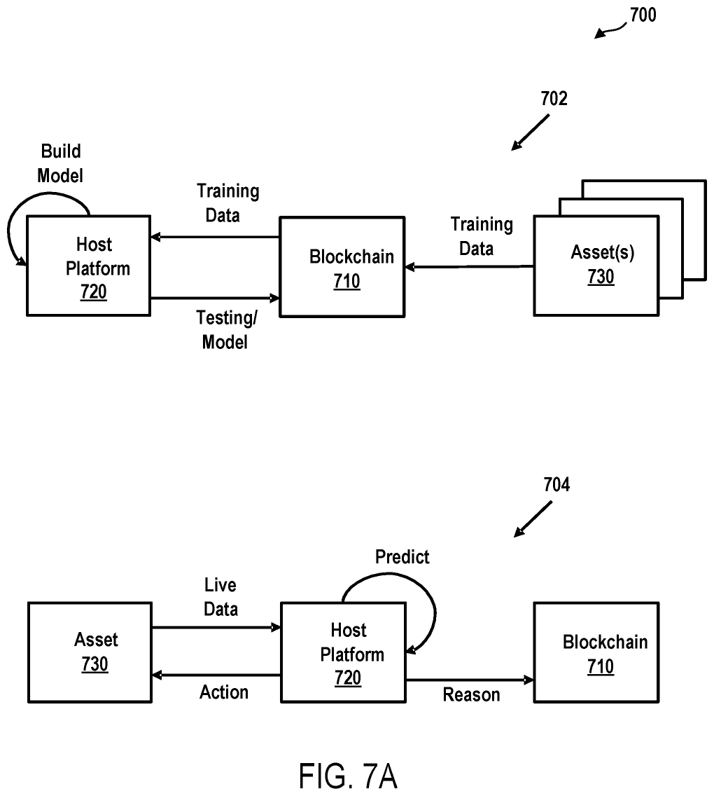

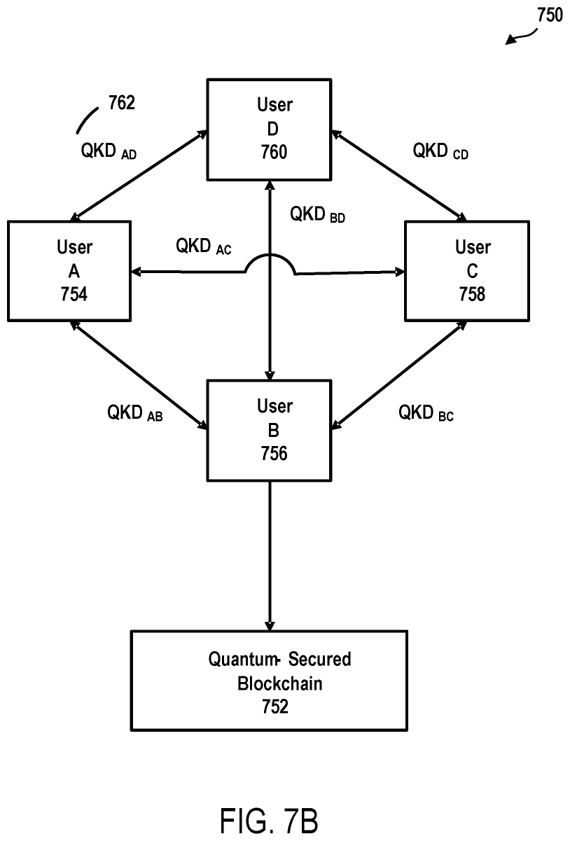

FIGS. 7A and 7B illustrate additional examples of use cases for blockchain which may be incorporated and used herein. In particular, FIG. 7A illustrates an example 700 of a blockchain 710 which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 7A, a host platform 720 builds and deploys a machine learning model for predictive monitoring of assets 730. Here, the host platform 720 may be a cloud platform, an industrial server, a web server, a personal computer, a user device, and the like. Assets 730 can be any type of asset (e.g., machine or equipment, etc.) such as an aircraft, locomotive, turbine, medical machinery and equipment, oil and gas equipment, boats, ships, vehicles, and the like. As another example, assets 730 may be non-tangible assets such as stocks, currency, digital coins, insurance, or the like.

The blockchain 710 can be used to significantly improve both a training process 702 of the machine learning model and a predictive process 704 based on a trained machine learning model. For example, in 702, rather than requiring a data scientist/engineer or other user to collect the data, historical data may be stored by the assets 730 themselves (or through an intermediary, not shown) on the blockchain 710. This can significantly reduce the collection time needed by the host platform 720 when performing predictive model training. For example, using smart contracts, data can be directly and reliably transferred straight from its place of origin to the blockchain 710. By using the blockchain 710 to ensure the security and ownership of the collected data, smart contracts may directly send the data from the assets to the individuals that use the data for building a machine learning model. This allows for sharing of data among the assets 730.

The collected data may be stored in the blockchain 710 based on a consensus mechanism. The consensus mechanism pulls in (permissioned nodes) to ensure that the data being recorded is verified and accurate. The data recorded is time-stamped, cryptographically signed, and immutable. It is therefore auditable, transparent, and secure. Adding IoT devices which write directly to the blockchain can, in certain cases (i.e. supply chain, healthcare, logistics, etc.), increase both the frequency and accuracy of the data being recorded.

Furthermore, training of the machine learning model on the collected data may take rounds of refinement and testing by the host platform 720. Each round may be based on additional data or data that was not previously considered to help expand the knowledge of the machine learning model. In 702, the different training and testing steps (and the data associated therewith) may be stored on the blockchain 710 by the host platform 720. Each refinement of the machine learning model (e.g., changes in variables, weights, etc.) may be stored on the blockchain 710. This provides verifiable proof of how the model was trained and what data was used to train the model. Furthermore, when the host platform 720 has achieved a finally trained model, the resulting model may be stored on the blockchain 710.

After the model has been trained, it may be deployed to a live environment where it can make predictions/decisions based on the execution of the final trained machine learning model. For example, in 704, the machine learning model may be used for condition-based maintenance (CBM) for an asset such as an aircraft, a wind turbine, a healthcare machine, and the like. In this example, data fed back from the asset 730 may be input the machine learning model and used to make event predictions such as failure events, error codes, and the like. Determinations made by the execution of the machine learning model at the host platform 720 may be stored on the blockchain 710 to provide auditable/verifiable proof. As one non-limiting example, the machine learning model may predict a future breakdown/failure to a part of the asset 730 and create alert or a notification to replace the part. The data behind this decision may be stored by the host platform 720 on the blockchain 710. In one embodiment the features and/or the actions described and/or depicted herein can occur on or with respect to the blockchain 710.

New transactions for a blockchain can be gathered together into a new block and added to an existing hash value. This is then encrypted to create a new hash for the new block. This is added to the next list of transactions when they are encrypted, and so on. The result is a chain of blocks that each contain the hash values of all preceding blocks. Computers that store these blocks regularly compare their hash values to ensure that they are all in agreement. Any computer that does not agree, discards the records that are causing the problem. This approach is good for ensuring tamper-resistance of the blockchain, but it is not perfect.

One way to game this system is for a dishonest user to change the list of transactions in their favor, but in a way that leaves the hash unchanged. This can be done by brute force, in other words by changing a record, encrypting the result, and seeing whether the hash value is the same. And if not, trying again and again and again until it finds a hash that matches. The security of blockchains is based on the belief that ordinary computers can only perform this kind of brute force attack over time scales that are entirely impractical, such as the age of the universe. By contrast, quantum computers are much faster (1000s of times faster) and consequently pose a much greater threat.

FIG. 7B illustrates an example 750 of a quantum-secure blockchain 752 which implements quantum key distribution (QKD) to protect against a quantum computing attack. In this example, blockchain users can verify each other's identities using QKD. This sends information using quantum particles such as photons, which cannot be copied by an eavesdropper without destroying them. In this way, a sender and a receiver through the blockchain can be sure of each other's identity.

In the example of FIG. 7B, four users are present 754, 756, 758, and 760. Each of pair of users may share a secret key 762 (i.e., a QKD) between themselves. Since there are four nodes in this example, six pairs of nodes exist, and therefore six different secret keys 762 are used including QKD_{AB}, QKD_{AC}, QKD_{AD}, QKD_{BC}, QKD_{BD}, and QKD_{CD}. Each pair can create a QKD by sending information using quantum particles such as photons, which cannot be copied by an eavesdropper without destroying them. In this way, a pair of users can be sure of each other's identity.

The operation of the blockchain 752 is based on two procedures (i) creation of transactions, and (ii) construction of blocks that aggregate the new transactions. New transactions may be created similar to a traditional blockchain network. Each transaction may contain information about a sender, a receiver, a time of creation, an amount (or value) to be transferred, a list of reference transactions that justifies the sender has funds for the operation, and the like. This transaction record is then sent to all other nodes where it is entered into a pool of unconfirmed transactions. Here, two parties (i.e., a pair of users from among 754-760) authenticate the transaction by providing their shared secret key 762 (QKD). This quantum signature can be attached to every transaction making it exceedingly difficult to tamper with. Each node checks their entries with respect to a local copy of the blockchain 752 to verify that each transaction has sufficient funds. However, the transactions are not yet confirmed.

Rather than perform a traditional mining process on the blocks, the blocks may be created in a decentralized manner using a broadcast protocol. At a predetermined period of time (e.g., seconds, minutes, hours, etc.) the network may apply the broadcast protocol to any unconfirmed transaction thereby to achieve a Byzantine agreement (consensus) regarding a correct version of the transaction. For example, each node may possess a private value (transaction data of that particular node). In a first round, nodes transmit their private values to each other. In subsequent rounds, nodes communicate the information they received in the previous round from other nodes. Here, honest nodes are able to create a complete set of transactions within a new block. This new block can be added to the blockchain 752. In one embodiment the features and/or the actions described and/or depicted herein can occur on or with respect to the blockchain 752.

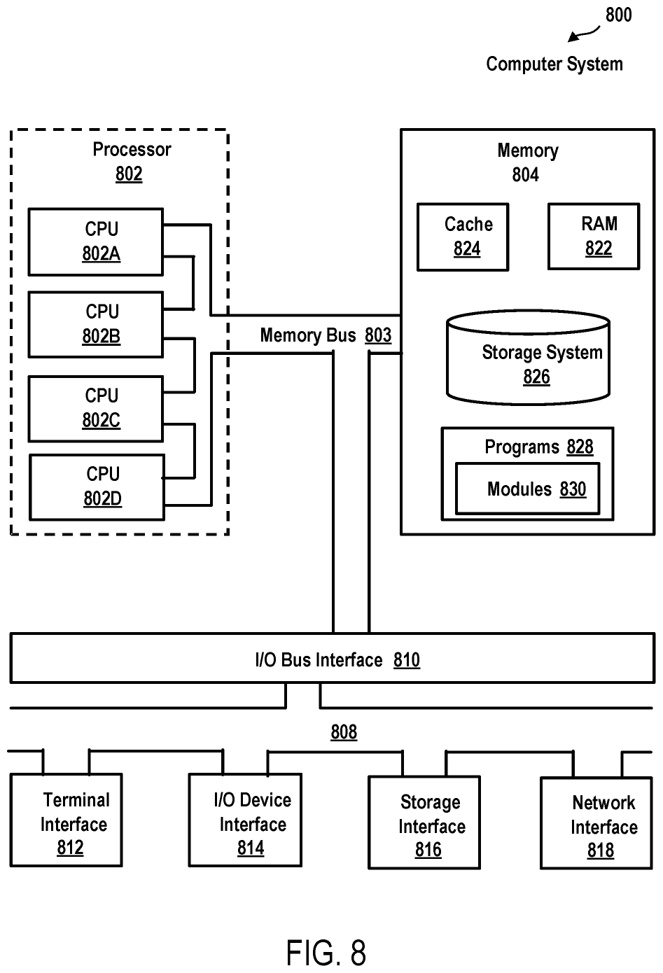

Referring now to FIG. 8, shown is a high-level block diagram of an example computer system 800 that may be used in implementing one or more of the methods, tools, and modules, and any related functions, described herein (e.g., using one or more processor circuits or computer processors of the computer), in accordance with embodiments of the present disclosure. This computer system may, in some embodiments, be a DPS 10 as described above. In some embodiments, the major components of the computer system 800 may comprise one or more CPUs 802, a memory subsystem 804, a terminal interface 812, a storage interface 816, an I/O (Input/Output) device interface 814, and a network interface 818, all of which may be communicatively coupled, directly or indirectly, for inter-component communication via a memory bus 803, an I/O bus 808, and an I/O bus interface unit 810.

The computer system 800 may contain one or more general-purpose programmable central processing units (CPUs) 802A, 802B, 802C, and 802D, herein generically referred to as the CPU 802. In some embodiments, the computer system 800 may contain multiple processors typical of a relatively large system; however, in other embodiments the computer system 800 may alternatively be a single CPU system. Each CPU 802 may execute instructions stored in the memory subsystem 804 and may include one or more levels of on-board cache.

System memory 804 may include computer system readable media in the form of volatile memory, such as random access memory (RAM) 822 or cache memory 824. Computer system 800 may further include other removable/non-removable, volatile/non-volatile computer system storage media. By way of example only, storage system 826 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 804 can include flash memory, e.g., a flash memory stick drive or a flash drive. Memory devices can be connected to memory bus 803 by one or more data media interfaces. The memory 804 may include at least one program product having a set (e.g., at least one) of program modules that are configured to carry out the functions of various embodiments.

One or more programs/utilities 828, each having at least one set of program modules 830 may be stored in memory 804. The programs/utilities 828 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 828 and/or program modules 830 generally perform the functions or methodologies of various embodiments.

Although the memory bus 803 is shown in FIG. 8 as a single bus structure providing a direct communication path among the CPUs 802, the memory subsystem 804, and the I/O bus interface 810, the memory bus 803 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 810 and the I/O bus 808 are shown as single respective units, the computer system 800 may, in some embodiments, contain multiple I/O bus interface units 810, multiple I/O buses 808, or both. Further, while multiple I/O interface units are shown, which separate the I/O bus 808 from various communications paths running to the various I/O devices, in other embodiments some or all of the I/O devices may be connected directly to one or more system I/O buses.

In some embodiments, the computer system 800 may be a multi-user mainframe computer system, a single-user system, or a server computer or similar device that has little or no direct user interface, but receives requests from other computer systems (clients). Further, in some embodiments, the computer system 800 may be implemented as a desktop computer, portable computer, laptop or notebook computer, tablet computer, pocket computer, telephone, smartphone, network switches or routers, or any other appropriate type of electronic device.

FIG. 8 depicts the representative major components of an example computer system 800. In some embodiments, however, individual components may have greater or lesser complexity than as represented in FIG. 8, components other than or in addition to those shown in FIG. 8 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

### Electronic Wallet Allowing Virtual Currency Expiration Date

System Overview

This disclosure considers use of an electronic wallet that allows a virtual currency using blockchain technology, to have an expiration date as one of a set of virtual currency usage rules (VCURs) associated with the virtual currency. Such virtual currency will be referred to herein as expiring virtual currencies (EVCs), i.e., blockchain virtual currency having usage rules associated it. Contrary to the EVC designation, the expiration date does not have to be an actual VCUR of the VCUR(s) associated with an EVC, and the use of the EVC term is simply used for the sake of conciseness. Also, “expiring virtual currencies” and “EVCs” will mean all virtual currencies that use blockchain technology and have at least one VCUR associated with it and may accommodate optional information in a transaction. The term “virtual currency” will be defined herein to include all blockchain virtual currencies as well as digital currencies for the sake of conciseness, and unless expressly indicated (by use of the term “regular virtual currency”), will not refer solely to the actual or normal virtual currency. The EVC may represent digital tokens that may also be referred to herein as “local virtual currencies”. Such an EVC may, for example, represent a currency token that, having expired after the specified deadline, may be made unusable or may be automatically transferred to a freely selected destination/transferee (e.g., charity organization or the like).

There are cases in which it is desirable to have purchases and/or payments be made to a certain set of entities according to VCURs, such as being within a particular time period. By way of example, it may be desirable to use EVCs for subsidies such as grants-in-aid or subsidies for economic stimulus measures in a country or a certain district that are to be spent within a certain period of time. Existing valid schemes for such a circumstance are limited to indirect schemes, such as gift certificates and coupons with expiration dates. In electronic money systems, such schemes are limited to point refunds with a limited period of time or the like. It may, in some circumstances, be desirable to develop a scheme for the use of electronic money by large organizations or entities, such as countries, special zones, or large-scale companies, which sets, as a VCUR, an expiration date to countermeasure costs, grants-in-aid, and the like, to thereby acquire immediate, effective and efficient results. Disclosed herein, according to some embodiments, is a mechanism for implementing EVCs in which a management body (e.g., municipality, corporation, or other such entity) distributes EVCs having VCURs and dedicated wallets to users.

The EVCs may be used, e.g., for payment in shops outside the local economic zone or for payment to users in the local economic zone. EVCs paid to the outside of the local economic zone are usable as general virtual currencies without expiration. The VCURs, such as the expiration date, may be determined by the management body, which is the entity creating the original VCURs for the EVCs. The expiration date may, for example, be either predetermined or may be extended, for example, to N days after each transaction is made. A scheme may be implemented such that an EVC, having expired without being used within the predefined set of EVC recipients, is transferred to a transfer destination (account) on a list of transfer destinations which have been specified in advance. The transfer destination may, in some embodiments, be a donor destination that receives the transfer as a gift. As a result, use of the EVCs within the expiration date and according to the VCURs may be promoted. In some embodiments, the system allows the transferee, such as the donee organization, to automatically issue a receipt, such as a donation certificate, for the transferred EVC, thereby contributing, for example, to a tax shelter and/or promotion of the donor. The predefined set of EVC recipients may be constructed to realize the above-described use of EVC.

In some embodiments, EVC destinations may be limited to those in an EVC Recipient Destination List (see Table 2 below). Recipients in this list may be classified into distribution destinations (Local, inside—or those who are within the set of predefined EVC recipients) who have an EVC wallet, and destinations without an EVC wallet (Global, outside—or those who are outside of the set of predefined EVC recipients). When sending money by specifying the destination (Local, inside) that have an EVC wallet, the transaction may be given deadline information, and the amount received by the remittance partner will be used within the expiration date or automatically sent when the expiration date is reached (or other VCUR is triggered). The amount will then be sent to the destination (e.g., charity). If a destination is specified (Global, outside) that does not have an EVC wallet and EVCs are sent to such a destination, the deadline information will not be added to the transaction. Remittance recipients of “Global, outside” can use a normal wallet and use the received amount as a normal virtual currency. with no limitation on the deadline or destination. In other words, the EVC wallet will send money according to the restriction due to the expiration date set in the transaction addressed to itself and the restriction that the destination is limited to the list due to the specifications of the dedicated wallet.

The following definitions and descriptions may apply to various terms used herein. For virtual currency, transactions are recorded in a distributed ledger (a blockchain) on a distributed peer-to-peer network. An original token can be implemented by using a space (such as the OP_RETURN field of a Bitcoin™) optionally usable in each virtual currency transaction. A local virtual currency, which may also be referred to as an EVC, is a medium for exchanging value in a form of token with an expiration date. Because of the use of the virtual currency blockchain, EVCs may have security and resistance against falsification which are equivalent to those of virtual currency. A local economic zone network, which may also be referred to as a predefined set of EVC recipients that limits the circulation range or scope of the EVCs, is defined as follows. Transactions of virtual currencies are carried out between an unspecified number of users, whereas transactions of local virtual currencies or EVCs may be carried out only between dedicated wallet applications distributed to specific users by an issuer. With this, a predefined set of EVC recipients, such as a local economic zone, network managed by the issuer may be constructed on the global, non-centralized network of virtual currency or other virtual currency. An apparatus for generating addresses and private keys generates virtual currency addresses between which transactions of local virtual currencies or EVCs may be carried out. The apparatus generates private keys corresponding to those addresses. The generated information is held in the wallet applications distributed to the specified users, which makes it possible to have each wallet application make a payment to another generated address.

Each dedicated wallet application may carry out a money transfer to another address inside or outside the predefined set of EVC recipients. The dedicated wallet application may obtain basic information, such as a list of destination addresses of trading partners, automatic transfer destinations, and expiration date coefficients by accessing a presenting apparatus regularly. The dedicated wallet application may extract balances not used for trades from the virtual currency blockchain, and extracts expired balances and automatically transfers them to the transfer destinations in the manner of a normal virtual currency transfer. The apparatus for inputting and presenting basic information is capable of receiving an input of basic information such as a list of addresses of specific users in the local economic zone network, automatic transfer destinations, and expiration date coefficient. The basic information may be referenced from and used by each dedicated wallet application on a regular basis. This apparatus may be managed by the issuer of EVCs.

As described below, the life of an EVC may be described in terms of phases. The first phase is the creating of an EVC by the issuer, who may, for example, transform normal virtual currencies (or other currencies) into EVCs by adding VCURs to them. In a second phase, the issuer may distribute the EVCs to a set of EVC recipients. To do this, the EVC recipients must have a special EVC wallet application, which may be set up by the issuer or by the EVC recipient by, for example, downloading the application to a device from an online store. Once the EVC wallet is set up, the issuer may transfer the EVCs to the EVC recipient. The life of the EVC continues with the EVC recipient, who stores the EVCs, when received from the issuer, in their EVC wallet.

In the next phase of the EVC life, the EVC use-or-auto-transfer phase by the EVC recipient, prior to any expiration specified in the VCURs, the EVC recipient may transfer the EVCs to others, but only to those designated in further VCURs by the issuer in an EVC recipient destination list, described below. Once the EVCs expire, however, they are automatically, and without EVC recipient (or other) intervention, transferred to a transferee, such as a charity. In some embodiments, the transferee is designated solely by the issuer. In other embodiments, the transferee may be designated (initially or by modifying the transferee of the issuer) by the EVC recipient, possibly subject to certain limitations. Also, in some embodiments, the EVC recipient, prior to EVC expiration, may transfer some of the EVCs to others, and such transfers may be made without the VCURs, i.e., as normal virtual currencies. In other embodiments, the EVC recipient may transfer the EVCs with the VCURs having the same, greater, or fewer restrictions, depending on the initial VCUR of the issuer. VCURs may transfer in the same or altered form across a plurality of sequenced transactions, potentially indefinitely, or they may terminate at some point and the EVCs may be translated into normal virtual currencies.

In some embodiments, the funds represented in the EVCs are transferred to the transferee without VCURs, i.e., as normal virtual currencies or other forms of currency. The EVC recipient may transfer the EVCs prior to expiration. In some embodiments, this transfer maintains the VCURs, and in others, the transfer may eliminate some or all of the VCURs. VCURs may be incorporated as a part of the transaction (e.g., the expiration date), or may be communicated as out-of-band (i.e., outside of normal virtual currency communications) communications (e.g., the EVC recipient destination list and transferee destination list described below), or both.

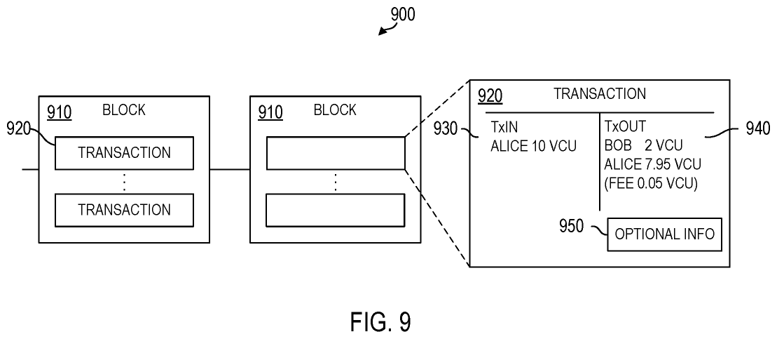

FIG. 9 is a block diagram that illustrates a distributed ledger (blockchain) virtual currency ledger 900 composed of a plurality of blocks 910, each block 910 comprising a plurality of transactions 920. The distributed ledger 900 is implemented on a distributed peer-to-peer network. A user of virtual currency is identified by a virtual currency address. A virtual currency user uses a wallet application and proves the ownership of a transferred amount in a transaction whose destination address is set to the address of the user by using a secret key paired with the address.

Virtual currencies of the transferred amount, the ownership of which is owned by the user, can be transferred to another virtual currency user. As can be seen in the illustrative example transaction 920, Alice starts with 10 virtual currency units (VCU) (TxIN) 930, and then transfers 2 virtual currency VCU to Bob. Recording a virtual currency transaction to the ledger 900 is carried out by a miner (mining operator) after the transaction is generated, and thus a fee (mining fee) of 0.05 VCU to be paid as the compensation for the miner is set in the transaction 920. The resultant outcome (TxOUT) 940 becomes a part of the recorded transaction 920. Due to the data structure of virtual currency transactions 920, optional information (meta data) 950 other than that related to transfer and reception of virtual currencies may be set to a virtual currency transaction. Depending on the implementation of the wallet application, this system may transfer any asset other than virtual currency and records information that is related to virtual currency and the transaction.

Transactions 920 are sequentially recorded in the virtual currency ledger 900. A wallet application sums up the transferred amount in each transaction 920 and regards the calculated amount as the usable balance. The wallet application manages a private key paired with the public key embedded in a transaction 920 to prove the ownership of the transferred amount in the transaction 920.

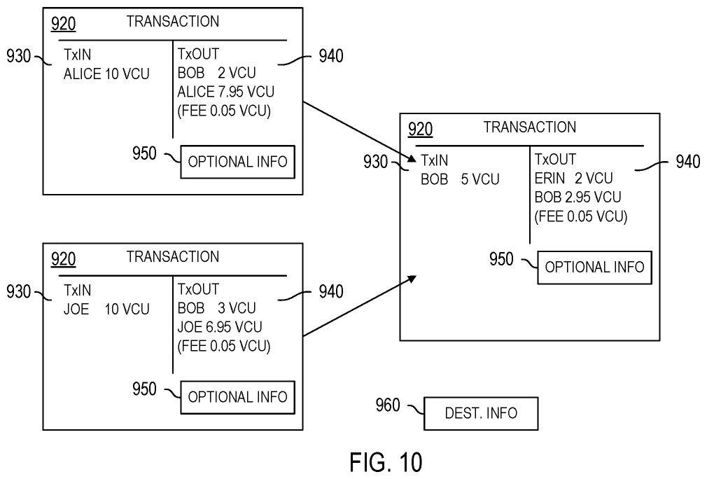

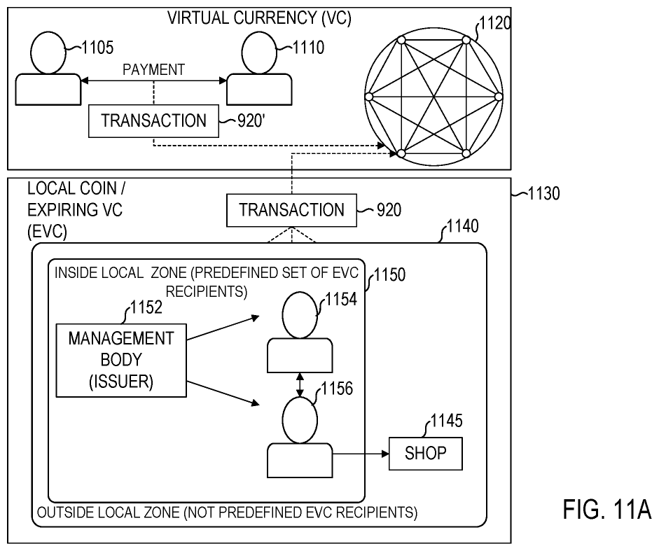

FIG. 10 is a block diagram illustrating transfers of two transferors (transactions 920 on the left) to a transferee (transaction 920 on the right). In these transactions 920, Alice starts with 10 VCU and then transfers 2 VCU to Bob, leaving Alice with 7.95 VCU 940 after a 0.05 VCU fee has been applied. Similarly, Joe starts with 10 VCU and then transfers 3 VCU to Bob, leaving Joe with 6.95 VCU 940 after a 0.05 VCU has been applied. The rightmost transaction 920 shows Bob's receipt of the 2+3 VCU from Alice and Joe as 5 VCU in the TxIN 930 of Bob's wallet application.

FIG. 10 further shows the rightmost transaction 920 as being a transaction in which Bob transfers 2 VCU to Erin. However, in this case, the 2 VCU to are in EVCs having expiration information stored in the optional information 950. The optional information 950 contains an area, such as the 80-byte area called OP_RETURN in Bitcoin™, for which free description is allowed in the virtual currency script. An expiration date may be specified in the optional information 950, and transferee destination(s) such as a donation destination(s) may be specified in the destination information 960, which may or may not constitute a part of the transaction 920. The dedicated wallet application described herein may be configured to carry out the restriction(s)/VCUR(s) and automated transfers to the transferee address upon expiration. This transaction 920 using the EVC may allow an automatic transfer, such as a donation of an expired amount of the EVC, to a designated transferee, such as a charity organization. In FIG. 10, in an illustrative example, if the expiration date is Aug. 1, 2020, and the transferee destination is the Red Cross®, then if the EVC has not been spent on or before Aug. 1, 2020, the EVC may then be transferred to a wallet of the Red Cross® automatically. In some embodiments, the EVC, upon initial use, either before or after expiration, reverts to a normal virtual currency and free of the VCURs. When the EVC is sent to an address other than the EVC wallet or when it is sent to the automatic destination due to expiration, the recipient uses the received amount in the normal virtual currency wallet, so there is no restriction on the deadline or destination—thus, the recipient can send regular virtual currency.

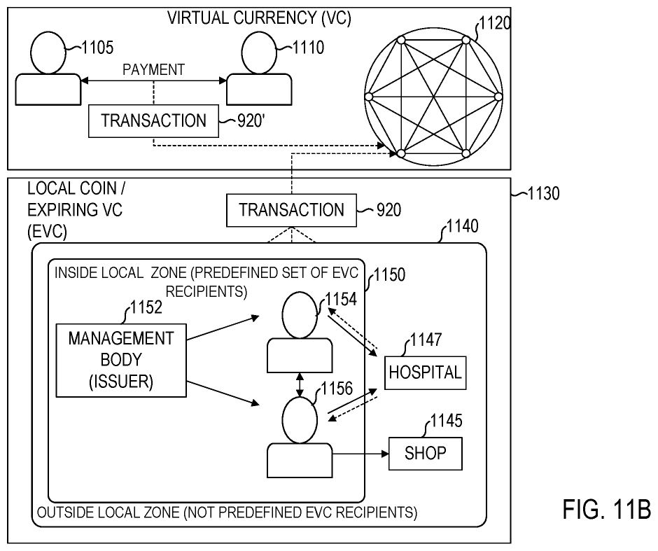

FIG. 11A is a block diagram that illustrates use of a predefined set of EVC recipients to which the EVC may be transferred. In a normal virtual currency transaction 920′, a first person 1105 directs a transfer of funds from their own virtual currency wallet to a second person 1110. The transaction is recorded in the blockchain ledger 1120 and shared among peers of the blockchain.

In a system 1130 utilizing an EVC (local coin), a management body (issuer) 1152 provides EVCs to a user (an EVC recipient) 1154 who may use the EVCs, within the scope of the VCURs, such as an expiration date. The issuer 1152 is the one that places the usage restriction (VCURs) on the virtual currencies to make them EVCs. The issuer 1152 may utilize an issuer device, such as the DPS 10 in performing the processes described herein. The issuer 1152 may issue original EVCs on e.g., a distributed peer-to-peer network having the high robustness provided by the virtual currency blockchain, which makes it possible to construct VCURs, such as those that define an internal recipient 1156 who are members of the predefined set of EVC recipients 1140, e.g., an economic zone (local economic zone), in which a circulation range or set of internal recipients 1156 for the EVCs is limited. The internal recipients 1156 are those who may receive an EVC and use it within its VCURs. In some embodiments, if the EVC recipient 1154 uses the EVC with an internal recipient 1156 (i.e., those within the predefined set of EVC recipients 1140, such as the local economic zone, who have EVC capable wallets) prior to the EVC's expiration, the EVCs lose their restrictive properties (from the VCURs) and may be used by the internal recipient 1156 as a normal virtual currency. In other embodiments, if the EVC recipient 1154 uses the EVC with an internal recipient 1156 prior to the EVC's expiration, the EVCs retain their restrictive properties (from the VCURs) and may be used by the internal recipient 1156 as EVCs. Any expired and unused EVC may be utilized in a transfer to a predesignated transferee 1147, such as a donation to a charitable organization or the like which has been set as a donation destination in advance.

In some embodiments, the issuer 1152 distributes the exclusive wallet to EVC recipients 1154 and other internal recipients 1156, and issues a transaction with an expiration date to the remittance partner at the address corresponding to the exclusive wallet. The EVC wallet can send money under the constraint of the expiration date set in the transaction addressed to itself and the constraint that the next destination is limited to the list (Table 2) due to the specifications of the dedicated wallet. These expiration dates and destination restrictions constitute the VCUR imposed on those who have their own wallet. The managing body 1152, who is the distributor of the EVC wallet, sets the expiration date and defines the distribution list. The managing body 1152 is also the entity that imposes the VCUR. In some embodiments, outsiders cannot be the subject of these VCURs. The predefined set of payees 1150 area may be viewed as a network of users who have their own EVC wallets.

In some embodiments, the transferee 1147, such as the donation destination (a hospital in FIG. 11B), may use the EVC as a general virtual currency, in other words, one without the VCURs (the expiration date having passed). Although the EVC recipients 1145 and the transferee 1147 are in the “EVC Recipient Destination List” (Table 2) and can be specified as destinations from the dedicated wallet, in some embodiments, neither the EVC recipients 1145 nor the transferee 1147 have a dedicated EVC wallet.

In some embodiments, a recipient 1156 who receives the EVC before the expiration date cannot use the received amount as normal virtual currency. The EVC wallet sends a transaction as EVC to the “Local(Inside)” destination described in the “EVC Recipient Destination List” (Table2), and to the “Global(Outside)” destination as normal virtual currency. The VCUR will be charged to EVCs received in the dedicated wallet. In addition, if the address for the recipient's 1156 regular virtual currency wallet is defined in the EVC Recipient Destination List (Table2), it is possible to send money to the address from the dedicated wallet, but it is not assumed. This is because if the recipient 1156 sends the entire amount of EVC with an expiration date to a regular virtual currency wallet that it owns, neither the definition of economic zone nor the EVC wallet will be meaningful. This provides a mechanism to send money as “regular virtual currency” to “Global (Outside)” destinations within the deadline and urge the EVC owner to use the EVCs within the deadline.

In other embodiments, layered VCURs may be provided by the issuer that may be changeable every time the EVC is transferred. In the example embodiment, the unused EVC may, in some implementations, contribute to activating charities and social contributions. When used in this manner, the holders of the EVCs (the initial EVC recipients 1154) may receive certificates of donation of the unused EVCs as evidence that these EVC recipients 1154 are entitled to enjoy tax benefits. In some embodiments, one or more of the EVC recipients 1154, issuer 1152, and internal recipient 1156 may utilize an EVC wallet as a special application that is loaded on their device, such as a DPS 10.

The issuer 1152 may be the one who imposes the VCURs on the EVCs or, in some embodiments, may impose additional VCURs on EVCs with pre-existing VCURs. The VCURs may also delineate to whom the EVCs may and may not be used as a part of transactions using the EVCs. This delineation may be made by defining a predefined set of EVC recipients 1150 (containing at least the internal recipients 1156) with which the EVCs may be used prior to expiration of the EVCs. The EVCs may not be used before expiration with those outside of the predefined set of EVC recipients 1140. The VCURs may be very flexible in defining who/what is in the predefined set of EVC recipients 1150 and who is not 1140. For example, the predefined set of EVC recipients 1150 may be defined by a geographic boundary. Such a definition may be in a form of, e.g., geofencing (including non-contiguous regions), and may include one or more countries, states, counties, cities, or any other definable area.

In some embodiments, such boundaries may apply to a residence or place of work of an internal recipient 1156 who are within the predefined set of EVC recipients. As described elsewhere herein, in some embodiments, after an initial use of the EVC by the original EVC recipient 1154 to the internal recipient 1156 prior to expiration, the internal recipient 1156 may not use the EVCs without their encumbrances (the VCURs) to other internal recipients 1156.

Although a VCUR may include a geophysical boundary, this is just one type of limiting rule that may be applied. However, there are other types of restrictions or rules that could be applied as part of the VCURs in addition to or in place of geophysical boundaries. For example, the VCURs may be limited to a corporation or its subsidies, a government entity, a type of business (e.g., green technology), particular cause (e.g., fighting breast cancer), or any other definable entity. Thus, the VCURs, according to some embodiments, may provide a means for constructing a local economic zone using EVCs constructed based on the blockchain 1120. The VCURs may also provide the means for facilitating the use of the EVCs so that they are used within the expiration dates and in the local economic zone or within the predefined set of EVC recipients. The predefined set of EVC recipients may be constructed among specific participants/transferees using the virtual currency blockchain ledger 1120. Then, EVCs (predetermined date or transaction date+N days) may be distributed in the local economic zone or the predefined set of EVC recipients. The EVCs may be readable by a wallet application specialized for the particular predefined set of EVC recipients, such as those within a local economic zone, and may be processed on the blockchain only within the expiration dates. In some embodiments, the EVC having gone beyond its expiration date may be then automatically transferred to a transferee 1147 that was identified by the management body/issuer 1152 (e.g., charity organization). In some embodiments, the transferee 1147 receives all of the virtual currencies free from encumbrances (the VCURs), in other embodiments, some other VCURs may be attached to them. Such additional VCURs may be any or all of the VCURs described herein, with the exception that the same expiration date should not be used, as it has already expired. By using the virtual currency blockchain ledger 1120, such as the virtual currency ledger, transactions may be carried out using an existing blockchain ledger, and thus not require constructing a new original blockchain.

Advantageously, various embodiments disclosed herein permit an effective and efficient use by a large organization such as large-scale companies, or countries, etc., of countermeasure costs, grants-in-aid, and the like, in a certain time period is made possible. Even when an EVC has expired, evidence of a transfer, such as a donation or the like, may be provided in the form of a receipt so that people who have received the EVCs may enjoy certain benefits, such as tax benefits, when expiration triggers the transfer.

FIG. 11B is a block diagram similar to FIG. 11A, but that additionally shows the transferee 1147 to whom unused EVCs may be automatically transmitted upon expiration of the EVCs (and/or in accordance with any of the other VCURs). In FIG. 11B, the transferee is a hospital 1147, which has been designated in the VCURs of the EVCs, as a receiver of the EVC resulting from the EVC passing its expiration date. Upon receiving the transfer, the hospital 1147 may issue a receipt of the transfer to the holder of the original EVC recipient 1154. If the transfer has been designated as a donation, then the receipt may be in the form of a certificate of donation. Such receipts may be utilized for e.g., recordkeeping, tax filings, etc.

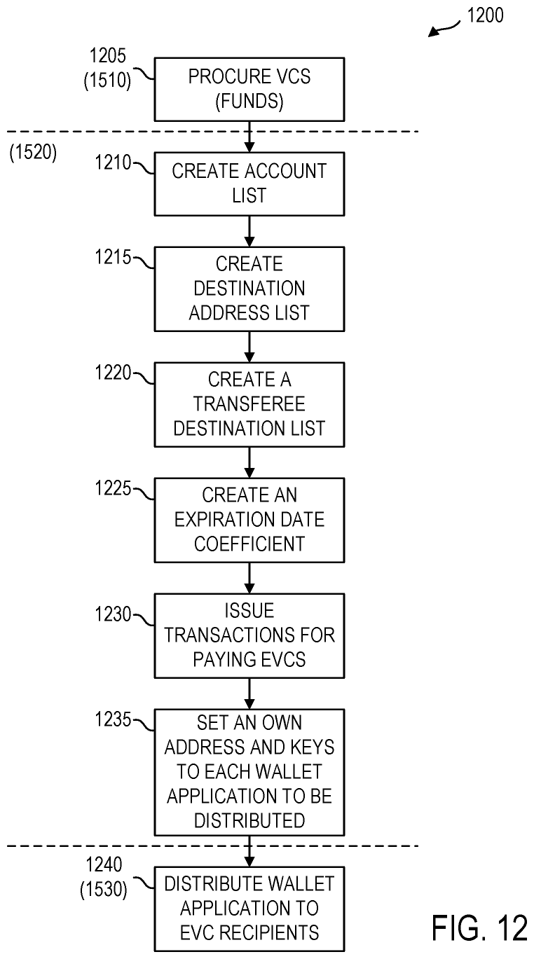

FIG. 12 is a flowchart illustrating a process 1200 for implementing some embodiments of a system used by the management body/issuer 1152 in creating and distributing EVCs. In operation 1205, the system receives and processes instructions by the issuer 1152 and proceeds to procure “regular” virtual currencies as the funds that are to be used as the EVCs. In operation 1210, an account list is created. This operation may include, for each user identified by the issuer 1152, generating: a private key, a public key, and a virtual currency address. The following table illustrates what such an account list may look like.

TABLE 1
Example Account List

| | | | virtual | Inside/Outside |
|---|---|---|---|---|
| EVC Recipient | Private | Public | currency | predefined set of |
| Identifier | Key | Key | Address | EVC recipients |
| Alice (1154) | 111 | xxx | XXX | Local (inside) |
| Bob (1156) | 222 | yyy | YYY | Local (inside) |
| Shop (1145) | 333 | zzz | ZZZ | Global (outside) |

The issuer 1152 may manage distribution target users to which the EVCs are to be distributed initially (the EVC recipients 1154) as well as the users that may become destinations (the internal recipients 1156 and the transferees 1147) from the EVC recipients 1154. The designation of a user as local (i.e., an internal recipient 1156) means the user is a participant in the predefined set of EVC recipients 1150, such as participants in a local economic zone. The designation of a user as global means the user is a specified trade partner outside of the set of recipients 1140, such as being outside of the local economic zone. By way of illustrative example, hospitals and/or pharmacies may participate as global trade partners to restrict the use of medical grants-in-aid; certain shops can be specified to facilitate circulation within a company group. Upon receiving information from the issuer 1152, the system may set up appropriate storage areas to structure and store this information, including a specialized EVC wallet application that may be distributed to users (or, more specifically, user devices, which may be DPSs 10) of the EVC.

In operation 1215, a destination list with addresses is created. This list may look similar to the account list of Table 1, with the exception that the private key is omitted. Table 2 below provides an example of an EVC recipient destination list.

TABLE 2
Example EVC Recipient Destination List

| | | | Inside/Outside |
|---|---|---|---|
| EVC Recipient | | virtual currency | predefined set of |
| Identifier | Public Key | Address | EVC recipients |
| Alice (1154) | xxx | XXX | Local (inside) |
| Bob (1156) | yyy | YYY | Local (inside) |
| Shop (1145) | zzz | ZZZ | Global (outside) |

In operation 1220, a transferee 1147 destination list, such as a donation destination list, is created by the issuer 1152, and formatted and stored in a memory of the system and/or respective devices within the system. The transferee destination list may specify entities which are to receive unspent EVCs upon their expiration. In some embodiments, the transferee destination list may permit entry of a ratio or percentage of expired EVCs the respective transferees are to receive. Table 3 below provides an example of a transferee (e.g., donation) destination list to which unused and expired EVCs are to be automatically transferred upon expiration, and ratios of the transfers.

TABLE 3
Example Transferee Destination List

| Transferee | | |
|---|---|---|
| Destination | virtual currency | |
| Identifier | Address | Rate/Ratio |
| Transferee | AAA | 80% |
| Destination | | |
| Organization AA | | |
| Transferee | BBB | 20% |
| Destination | | |
| Organization BB | | |

In operation 1225, in some embodiments, an expiration date coefficient is created by the issuer 1152 and stored in a memory of the system and/or respective devices of the system. In some embodiments, and according to one example method for doing this, the expiration date is to set a value N as the number of days beyond a current (issue) date as the expiration date for each transaction. For example, if the EVC creation/issue date is Oct. 14, 2020, and N is set to five, the expiration date would then be Oct. 19, 2020. In other words, N may serve as a delta value of time from the creation of the EVC. Other events may serve as a trigger besides the EVC creation date. For example, the Easter holiday, which varies from year-to-year, may serve as a trigger for the expiration. In other embodiments, a fixed date may be set that does not change based on the EVC creation date. The trigger does not have to be time-based, but rather may be event based. By way of example, the trigger may be based on an event defined as seasonal rainfall exceeding a particular amount. More complex rules for triggering may be implemented as well, using, e.g., Boolean logic. For example, the trigger may be, “the first occurring of seasonal rainfall=20 cm and Aug. 15, 2020”. Triggering events may be any type of event: a time-related event, weather conditions, business conditions, performance conditions, etc.

In operation 1230, a transaction may be issued for paying EVCs to the addresses which are on the distribution list and which are inside the predefined set of EVC recipients, such as an economic zone. By way of example, a transaction 920 may be created in which the TxIN 930 shows the issuer with 20 VCU, and the TxOUT 940 showing Alice with 19.95 VCU, and a fee of 0.05 VCU. An expiration date of Mar. 8, 2021 at 10:00 am may be specified in the optional information 950 of the transaction 920. This optional information may be written into the regular virtual currency-specific OP_RETURN region (which is 80 bytes), and this information may include the expiration date and, optionally, time, and an identification of the EVC—for example: LOCAL_VCU_20201910. With this information, the EVC possesses a balance with an expiration date set at the time of its distribution. The 80-byte limitation of the OP_RETURN for some virtual currencies limits the amount of information that can be passed in the transaction data, and metadata described in the tables herein is passed using the EVC wallet application. However, other blockchains may be able to accommodate larger optional data sizes permitting some or all of the Table data or other VCURs to be passed within the transaction itself.

In some embodiments, in operation 1230 in which the issuer 1152 issues an EVC to the address of the EVC wallet distribution destination, the value N may be changed for each address. However, the value N cannot be changed independently when sending an EVC from the EVC wallet address (1154, 1156) that is the distribution destination. It is assumed that one of the following may be set as the expiration date in the transaction that sends an EVC from the EVC wallet address (1154, 1156) that is the distribution destination.
Current (payment execution) date+number of days N
The date the management entity first specified when issuing the EVC

In the former, the expiration date may be extended with each transaction, but in the latter, the expiration date remains unchanged from the time of issue.

In operation 1235, the system sets an “own” address and keys to each EVC wallet application to be distributed. For example, an EVC wallet application for Alice may be set to Address: XXX, Private Key: 111, and Public Key: xxx. An EVC wallet application for Bob may be set to Address: YYY, Private Key: 222, and Public Key: yyy. This information, while being embedded in the EVC wallet, need not be disclosed to the user of the EVC wallet.

In operation 1240, the EVC wallet application containing the particular user information may be distributed to the respective user, such as the EVC recipient 1154, of each wallet (or EVC wallet applications).

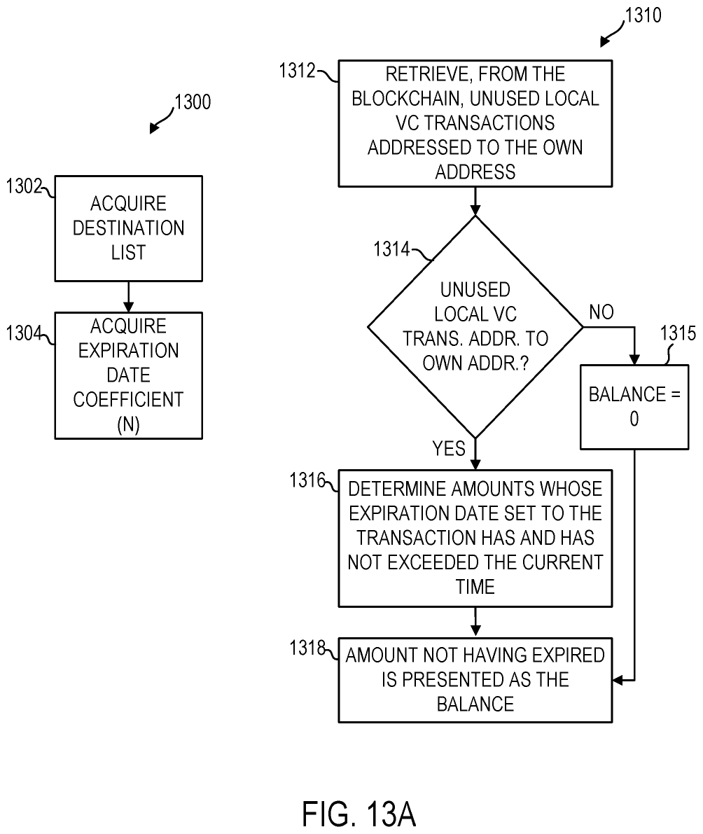

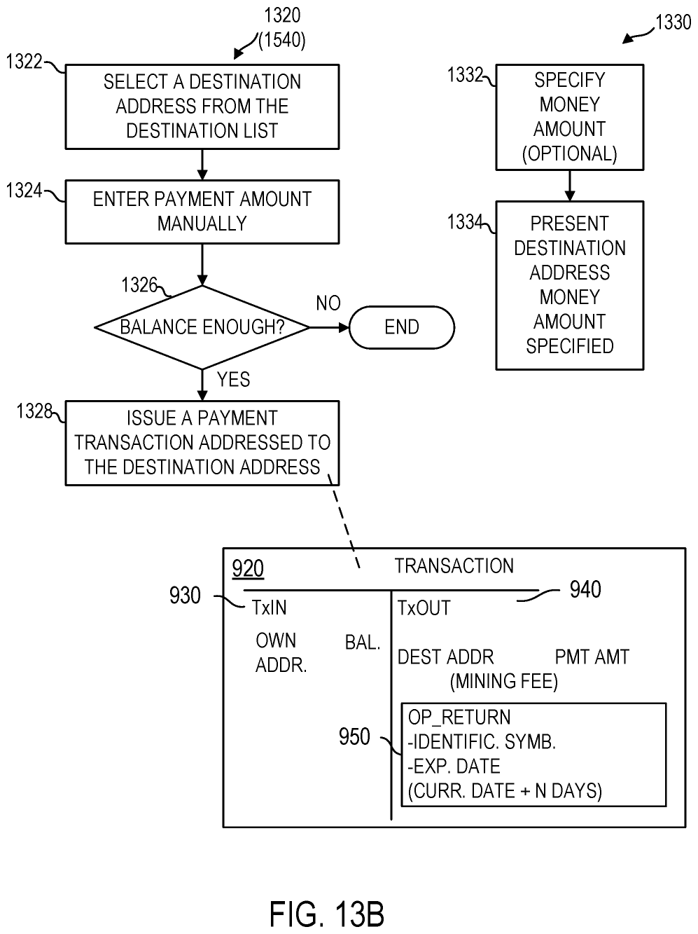

FIGS. 13A & 13B contain flowcharts of processes that may be utilized by the EVC recipients 1154 via the EVC wallet application on their devices. In an acquisition of relevant information process 1300, the EVC recipient 1154 may receive, for example a destination list, such as the EVC recipient destination list illustrated in Table 2. The EVC recipient destination list may be acquired by the EVC recipient 1154 in operation 1302, along with an expiration date coefficient (N), as described above, in operation 1304. Other structures of data may be used to convey the same or similar data to the EVC recipient 1154, and the information may be passed using, e.g., regular virtual currency functions. The “ACQUIRE DESTINATION LIST” and the value N may be acquired through the communication between the EVC wallet and the server system, and not through the Blockchain. The acquisition of this information may be done by obtaining it from the server system at the time of activating the EVC wallet or at regular time intervals during activation.

In a presentation of the balance process 1310 (to the EVC recipient 1154), in operation 1312, unused EVC transactions addressed to the EVC recipient 1154 are retrieved from the blockchain. For example, it may be determined that Alice, as an EVC recipient, has 20 VCUs as EVCs (EVCTCs). A determination may be made, in operation 1314, if there are any unused EVC transactions addressed to the EVC recipient 1154 present. If not (1314:N), then, as shown in block 1315, the balance is 0, and processing proceeds to operation 1318. If so (1314:Y), then in operation 1316, the system determines the amounts of the EVCTCs whose expiration date has not yet passed. In operation 1318, the amount of EVCTCs that have not expired is presented as the balance. In the example, fifteen of Alice's EVCTCs have not expired, and so this is presented as her balance. The determination of whether a transaction 920 is addressed to the EVC recipient's address may be made on the basis of the TxOut 940 of each transaction 920 involving the EVC recipient 1154. The determination of whether a transaction 920 is one with original EVCs may be made on the basis of the description (identifier and expiration date) in OP_RETURN in the optional information 950.

FIG. 13B continues various processes that may be utilized by the EVC recipients 1154. Process 1320 illustrates payment using an EVC. In operation 1322, the EVC recipient 1154 may select the internal recipient 1156 by selecting, e.g., a destination address from the EVC recipient destination list using their EVC wallet application. Referring to Table 2 above, the EVC recipient 1154, Alice, may select Bob as the internal recipient 1156, i.e., the person to receive a payment of an EVC. In operation 1324, the EVC recipient 1154 may indicate a payment amount to pay the internal recipient (Bob) 1156—for example, 1 VCU. In operation 1326, the wallet application of the EVC recipient 1154 checks to see if the balance in the EVC recipient's wallet is adequate to make the payment. If not (operation 1326:N), then this process ends, and, in some embodiments, may present an indication of this (such as a message displayed on a screen of the user's device) to the EVC recipient 1154. Otherwise (operation 1326:Y), the EVC recipient's 1154 wallet application, in operation 1328, issues a payment transaction addressed to the internal recipient (Bob) 1156.

The transaction 920 in FIG. 13B illustrates an example transaction that may take place. As the TxIN 930, the EVC recipient's address shows their (Alice's) balance. As the TxOUT 940, the destination (internal recipient's 1156) address and the payment amount is shown (less, e.g., the mining fee, as discussed above). The OP_Return field 950 may include an identification symbol and an expiration date (e.g., the current date, plus N days). The identification symbol may be provided to identify the EVC for the sake of transaction tracking and aggregation—it may or may not actually used. In some embodiments, only EVC can be sent to the dedicated EVC wallet, and therefore, the EVC wallet only needs to identify the transaction destined for its address to determine if it is an EVC.

The determination of whether a transaction is addressed to the internal recipient's 1156 address may be made on the basis of the TxOut 940 of each transaction 920. The determination of whether a transaction 920 is one with original EVCs may be made on the basis of the description (identifier and expiration date) in OP_RETURN 950. In a case of the transfer destination being other than the dedicated wallets (i.e., a trade with one who is “Global, outside” in “EVC Recipient Destination List” (Table 2)), the EVCs may be usable as normal regular virtual currencies.

The process 1330 illustrates reception of the EVC transaction and use by the internal recipient 1156 or the transferee 1147. Process 1330 describes the process by which the recipient displays the information (destination address, amount) required to send the EVC to the sender. In some embodiments, the EVC wallet may display and read a quick response (QR) code. For its use by these latter two entities (1156, 1147), the VCURs have been removed, and the EVCs are transformed into regular virtual currencies which may be used to make a purchase with and external recipient 1145, such as a shop.

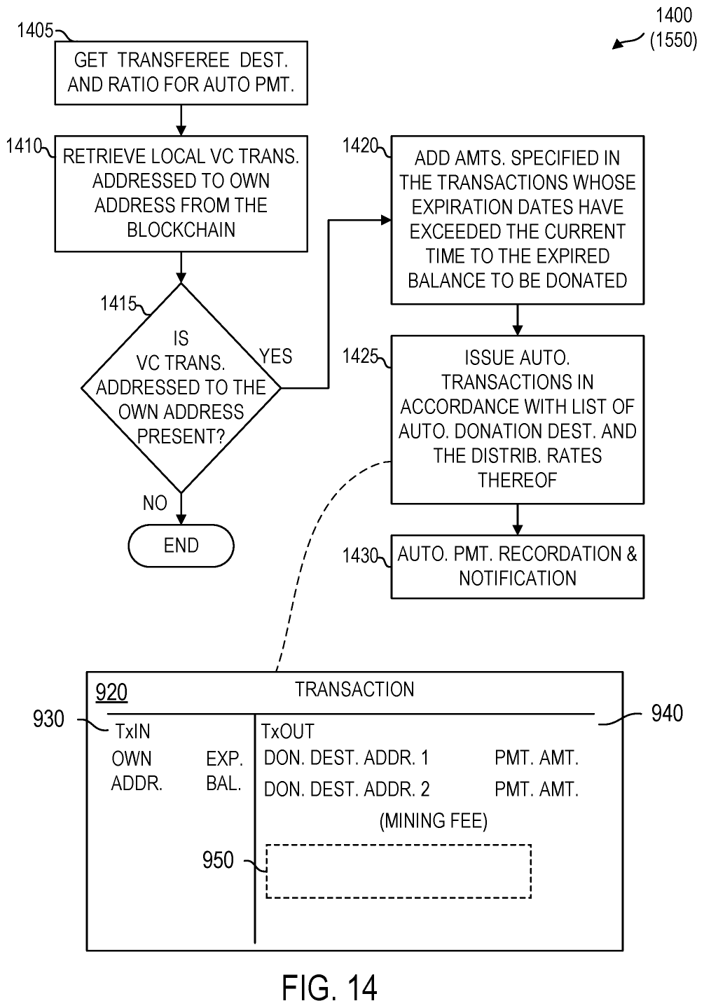

FIG. 14 is a flowchart illustrating a process 1400 for the automatic payment to the transferee 1147, such as the donee (e.g., the hospital illustrated in the FIGS.). Each EVC wallet application may hold expiration dates and times of EVCs set in each unused transaction (i.e., a transaction constituting a balance of the EVC wallet application). The wallet application may automatically initiate an automatic payment at the time of expiration. An expired balance may then be distributed in accordance with the VCURs, such as the ratios set to automatic donation destinations in advance.

In operation 1405, the EVC wallet application may get the transferee 1147 (e.g., the donee) destination and the ratio for the various transferees 1147 if such a ratio is present (or, put another way, if a single transferee gets 100% of the transfer). This information may be provided, for example, in the form of Table 3 described above. In operation 1410, the EVC wallet application may retrieve the EVC transaction addressed to the EVC recipient 1154 from the blockchain. If, in operation 1415, such an EVC transaction is not present (1415:N), then this process ends. Otherwise (1415:Y), in operation 1420, for those EVC transactions whose expiration dates have passed, the EVC wallet application may add the EVC transaction amounts.

Then, in operation 1425, the EVC wallet application may automatically issue transactions in accordance with the transferee 1147 destinations of the transferee destination list (e.g., Table 3). The transaction 920 shown in FIG. 14 illustrates this with the EVC recipient 1154 listed in the TxIN 930 description, and the transferee (e.g., donee) destination addresses and the respective payment amounts in the TxOUT 940 description. In this embodiment, the optional information 950 is not described in OP_RETURN, and the transactions are usable as normal virtual currencies at the destination of the transferee 1147. In the case of the transferee destination list presented in Table 3, when the expired balance is 1000, a payment of 800 is made to transferee destination organization AA and a payment of 200 is made to transferee destination organization BB.

In operation 1430, transaction ID(s) of the automatic payment(s) to the transferee(s) 1147 may be recorded and notification (e.g., in the form of a receipt for the transfer) may be sent back to the EVC recipient 1154 (the owner of the EVC wallet). The record of the automatic payment may be presented to the EVC recipient 1154 and output in a predetermined format. The transaction may be searched for in the virtual currency blockchain with the transaction ID by using a Blockchain Explorer or the like, and then output for viewing or other use.

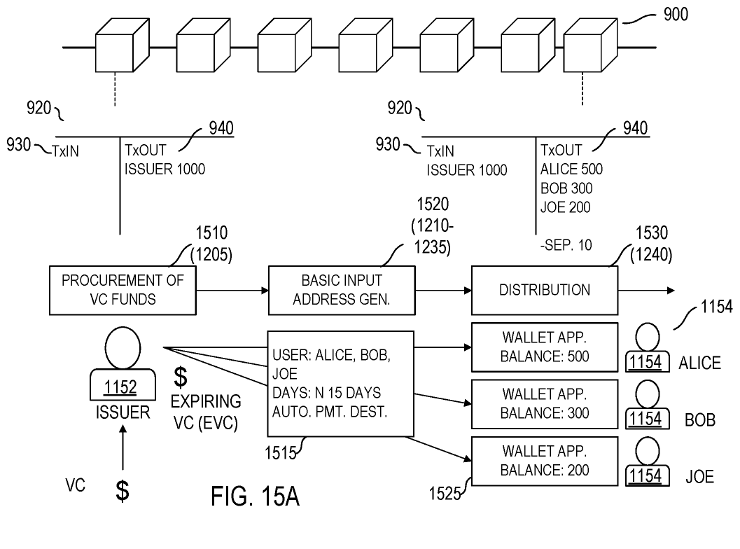

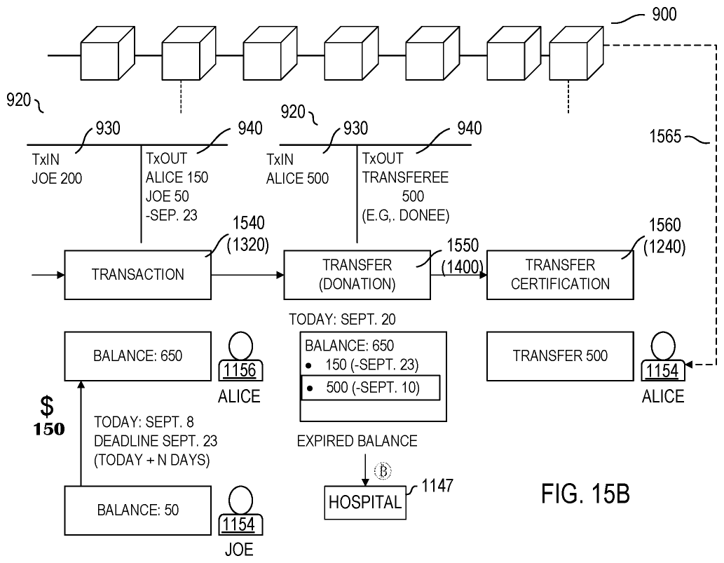

FIGS. 15A and 15B are parts of a combination block-process diagram illustrating components and interactions of these components for operating the system, with reference number indications to the processes and operations described above. As shown in FIG. 15A, the issuer 1152 may procure regular virtual currencies and convert them into EVCs (operation 1510 (1205)). The leftmost transaction 920 shows that there is nothing in the TxIN 930 column, but, by way of example, the issuer 1152 utilizes 1000 virtual currency and converts it into 1000 in EVC. Setting these as the VCURs are shown in block 1515. In operation 1520 (1210-1235), basic input address generation may be performed, in which Alice, Bob, and Joe are designated as EVC recipients 1154. The EVCs are set to expire where N=15 days from issuance of the EVCs.

In operation 1530 (1240), the actual distribution of the EVCs takes place to the respective EVC wallets 1525 of the EVC recipients 1154, Alice, Bob, and Joe. The rightmost transaction 920 shows that the issuer 1152 is distributing 1000 EVC (TxIN 930) to Alice 500, Bob 300, and Joe 200 as EVC recipients 1154. The service fee, which may be present in the transaction, is not shown for the sake of simplicity.

Turning to FIG. 15B, in operation 1540 (1320), a transaction takes place between an EVC recipient 1153 (Joe), and an internal recipient 1156 (Alice). Joe transfers 150 in EVC to Alice who has an existing balance of 650 in her EVC wallet. The leftmost transaction 920 shows Joe with 200 in EVC at the TxIN 930, and the TxOUT 940 shows Alice with 150 EVC and Joe with 50 EVC, both having an expiration date of September 23.

In operation 1550 (1400), a transfer from the EVC recipient 1154 to the transferee 1147 has been automatically triggered by the expiration of some of the EVC. The focus date of the transfer 1550 operation is September 20. Since the EVC recipient 1154 has EVC in their wallet, with 500 EVC having expired from the wallet and 150 remaining unexpired, an automatic transmission is made to the transferee 1147. In the illustrated transfer 1550, the transferee 1147 is the hospital. The rightmost transaction 920 illustrates this, with 500 EVC of Alice (the expired EVC) being shown as the TxIN 930, and the TxOUT 940 showing the results of the automatic transfer to the transferee. The 150 EVC amount remains in Alice's wallet until it expires at a later date. Operation 1560 (1440) simply illustrates that a certification, such as a receipt or other form of acknowledgment for the automatic transfer, may be provided 1565 to the EVC recipient 1154 Alice so that she has a record of the EVC transfer. The transaction between Joe and Alice is between dedicated EVC wallets, and the 150 EVC paid to Alice has an expiration date.

### Technical Application

The one or more embodiments disclosed herein accordingly provide an improvement to computer technology. For example, an improvement to a digital transaction ledger and additional flexibility to the data and transactions it supports allows for a more efficient and effective computer transaction documentation that include greater flexibility and security. One technical problem solved herein is that certain usage rules may not fit within the transaction data itself. As is used here, the standard virtual currency transaction allows 80 bytes for its optional data, but the complex VCURs do not fit within that limited space. Nonetheless, the inclusion of partial VCURs within this limited optional data allows it to be recognized as an EVC. Utilization of out-of-band communications for the remainder of the VCURs advantageously allows substantially more complex VCURs to be applied to EVCs than might otherwise be possible.

### Computer Readable Media

The present invention may be a system, a method, and/or a computer readable media at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method comprising using a processor of a device of an expiring virtual currency (EVC) wallet user, the processor configured for:
retrieving an EVC transaction associated with a blockchain and addressed to an address associated with an EVC wallet, the EVC transaction comprising an expiration date for the EVCs, the EVCs being subject to virtual currency user rules (VCURs) of which the expiration date is a part of;
determining whether the expiration date of the EVCs in the EVC transaction has passed; and
based on a first condition that the expiration date has passed, automatically, and without user intervention, transferring the EVCs to a transferee designated in the VCURs.

2. The method of claim 1, further comprising:
obtaining the transferee from a transferee destination list;
wherein the EVCs are transferred to the transferee as virtual currencies without the VCURs.

3. The method of claim 2, wherein the transferee destination list is received out of band from normal blockchain transactions.

4. The method of claim 1, further comprising receiving a receipt for the transfer of the EVCs to the transferees.

5. The method of claim 1, wherein the expiration date is stored in an optional information field of the transaction that is recorded in the blockchain.

6. The method of claim 1, wherein the expiration date is a number of days after past the creation of the transaction.

7. The method of claim 1, wherein the transferee includes a plurality of transferees, each indicating a portion of the EVCs they are each to receive;
the method further comprising:
transferring a respective portion of the EVCs to each transferee corresponding to the indicated portion.

8. The method of claim 1, further comprising:
acquiring an EVC recipient destination list defining a set of predefined recipients with whom the EVCs may be transferred by the EVC user, the EVC recipient destination list forming a part of the VCURs; and
based on a second condition that the expiration date has not passed, transferring the EVCs to a recipient of the set of predefined recipients in the VCURs.

9. The method of claim 8, further comprising:
obtaining the recipient from the EVC recipient destination list;
wherein the EVCs are transferred to the recipient as virtual currencies with the VCURs.

10. The method of claim 8, further comprising:
receiving a destination address of a recipient selected from the EVC recipient destination list;
receiving an entered payment amount;
making a sufficiency determination that the EVC wallet has an EVC balance greater than or equal to the entered amount; and
responsive to the sufficiency determination being true, transferring the entered payment amount from the EVC wallet to the recipient.

11. The method of claim 10, wherein the transferring of the entered payment amount is transferred without the VCURs.

12. An expiring virtual currency (EVC) apparatus, comprising:
a memory; and
a processor that is configured to:
retrieve an EVC transaction associated with a blockchain and addressed to an address associated with an EVC wallet, the EVC transaction comprising an expiration date for the EVCs, the EVCs being subject to virtual currency user rules (VCURs) of which the expiration date is a part of;
determine whether the expiration date of the EVCs in the EVC transaction has passed; and
based on a first condition that the expiration date has passed, automatically, and without user intervention, transfer the EVCs to a transferee designated in the VCURs.

13. The apparatus of claim 12, wherein the processor is further configured to:
obtain the transferee from a transferee destination list;
wherein the EVCs are transferred to the transferee as virtual currencies without the VCURs.

14. The apparatus of claim 13, wherein the processor is further configured to:
acquire an EVC recipient destination list defining a set of predefined recipients with whom the EVCs may be transferred by the EVC user, the EVC recipient destination list forming a part of the VCURs; and
based on a second condition that the expiration date has not passed, transfer the EVCs to a recipient of the set of predefined recipients in the VCURs.

15. A computer program product for an expiring virtual currency apparatus, the computer program product comprising:
one or more computer readable storage media, and program instructions collectively stored on the one or more computer readable storage media, the program instructions comprising program instructions to:
retrieve an EVC transaction associated with a blockchain and addressed to an address associated with an EVC wallet, the EVC transaction comprising an expiration date for the EVCs, the EVCs being subject to virtual currency user rules (VCURs) of which the expiration date is a part of;
determine whether the expiration date of the EVCs in the EVC transaction has passed; and
based on a first condition that the expiration date has passed, automatically, and without user intervention, transfer the EVCs to a transferee designated in the VCURs.

16. The computer program product of claim 15, wherein the program instructions further configure the processor to:
acquire an EVC recipient destination list defining a set of predefined recipients with whom the EVCs may be transferred by the EVC user, the EVC recipient destination list forming a part of the VCURs; and
based on a second condition that the expiration date has not passed, transfer the EVCs to a recipient of the set of predefined recipients in the VCURs.

17. An expiring virtual currency (EVC) system, comprising:
an EVC issuer device, comprising:
a memory; and
a processor that is configured to:
create an account list comprising a plurality of account records, each comprising an indicator as to whether an EVC recipient associated with the EVC recipient identifier is inside or outside of a predefined set of EVC recipients, wherein the account records correspond to a plurality of EVC recipients;
create an EVC recipient destination list comprising a plurality of destination records, each comprising the EVC recipient identifier, the public key, the virtual currency address, and the indicator as to whether the EVC recipient is inside or outside of a predefined set of EVC recipients;
create a value related to an expiration date for the EVCs;
set an EVC recipient address and security keys for each of a plurality of EVC wallets used to hold EVCs for the EVC recipients; and
distribute said each of the EVC wallets to respective said EVC recipients.

18. The system of claim 17, wherein the processor of the EVC device is further configured to:
receive a destination address of a recipient selected from the EVC recipient destination list;
receive an entered payment amount;
make a sufficiency determination that the EVC wallet has an EVC balance greater than or equal to the entered amount; and
responsive to the sufficiency determination being true, transfer the entered payment amount from the EVC wallet to the recipient.

19. The system of claim 17, wherein:
the transferring of the entered payment amount is transferred without the VCURs;
the transferee includes a plurality of transferees, each indicating a portion of the EVCs they are each to receive; and
the processor of the EVC device is further configured to transfer a respective portion of the EVCs to each transferee corresponding to the indicated portion.

20. The system of claim 17, wherein the processor of the EVC issuer device is further configured to:
procure initial virtual currencies; and
issue transactions for EVC recipients by utilizing the initial virtual currencies to create a transaction by including an amount and the value related to the expiration date.

21. The system of claim 17, wherein:
each of the plurality of account records comprises an EVC recipient identifier, a private key, a public key, and a virtual currency address; and
the EVC issuer device processor is further configured to:
create a transferee destination list comprising a plurality of transferee destination records, each comprising a transferee destination identifier, and a virtual currency address.

22. A computer implemented method comprising using a processor of a device of an expiring virtual currency (EVC) issuer, the processor configured for:
creating an account list comprising a plurality of account records, each comprising an EVC recipient identifier, a private key, a public key, a virtual currency address, and an indicator as to whether an EVC recipient associated with the EVC recipient identifier is inside or outside of a predefined set of EVC recipients, wherein the account records correspond to a plurality of EVC recipients;
creating an EVC recipient destination list comprising a plurality of destination records, each comprising the EVC recipient identifier, the public key, the virtual currency address, and the indicator as to whether the EVC recipient is inside or outside of a predefined set of EVC recipients;
creating a value related to an expiration date for the EVCs;
setting an EVC recipient address and security keys for each of a plurality of EVC wallets used to hold EVCs for the EVC recipients; and
distributing said each of the EVC wallets to respective said EVC recipients.

23. The method of claim 22, further comprising:
procuring initial virtual currencies; and
issuing transactions for EVC recipients by utilizing the initial virtual currencies to create a transaction by including an amount and the value related to the expiration date.

24. The method of claim 22, further comprising:
creating a transferee destination list comprising a plurality of transferee destination records, each comprising a transferee destination identifier, and a virtual currency address.

25. The method of claim 24, wherein the transferee is one of a plurality of transferees, and each of the plurality of transferees has associated with it a percentage or ratio of amount of EVCs associated with the transfer.
